(19) United States
(12) Patent Application Publication
(10) Pub. No.: US 2017/0227693 A1
(43) Pub. Date: Aug. 10, 2017

(54) OPTICAL MEMBER AND IMAGE DISPLAY DEVICE

(71) Applicant: FUJIFILM Corporation, Tokyo (JP)

(72) Inventors: Yoji ITO, Kanagawa (JP); Daisuke KASHIWAGI, Kanagawa (JP); Michio NAGAI, Kanagawa (JP); Akira YAMAMOTO, Kanagawa (JP); Nobuhiko ICHIHARA, Kanagawa (JP); Hideyuki NAKAMURA, Kanagawa (JP)

(73) Assignee: FUJIFILM Corporation, Tokyo (JP)

(21) Appl. No.: 15/496,646

(22) Filed: Apr. 25, 2017

Related U.S. Application Data
(63) Continuation of application No. PCT/JP2015/079638, filed on Oct. 21, 2015.

(30) Foreign Application Priority Data
Oct. 31, 2014 (JP) 2014-222837

(51) Int. Cl. G02B 5/26; G06F 3/042

(52) U.S. Cl. CPC G02B 5/26; G06F 3/0421

(57) ABSTRACT

An optical member and an image display device including an optical member having a support, an underlayer, and a wavelength selective reflection portion in this order, in which the wavelength selective reflection portion has wavelength selective reflecting properties, the wavelength selective reflection portion has a cholesteric structure which has a stripe pattern including bright portions and dark portions in a cross-sectional view of the wavelength selective reflection portion when observed with a scanning electron microscope, the underlayer absorbs invisible light, and a wavelength range where the wavelength selective reflection portion has wavelength selective reflecting properties overlaps a wavelength range of invisible light absorbed by the underlayer. In the optical member, a Signal/Noise ratio is high which is a ratio of a reflectance of the wavelength selective reflection portion to a reflectance of the underlayer in a wavelength range where the wavelength selective reflection portion has wavelength selective reflecting properties.

### CROSS-REFERENCE TO RELATED APPLICATIONS

This application is a Continuation of PCT International Application No. PCT/JP2015/079638, filed on Oct. 21, 2015, which claims priority under 35 U.S.C. Section 119(a) to Japanese Patent Application No. 2014-222837 filed on Oct. 31, 2014. Each of the above applications is hereby expressly incorporated by reference, in its entirety, into the present application.

### BACKGROUND OF THE INVENTION

1. Field of the Invention

The present invention relates to an optical member and an image display device. More specifically, the present invention relates to an optical member having a high Signal/Noise ratio and an image display apparatus in which the optical member is used, the Signal/Noise ratio being a ratio of a reflectance of a wavelength selective reflection portion to a reflectance of an underlayer in a wavelength range where the wavelength selective reflection portion has selective reflecting properties.

2. Description of the Related Art

A material having a cholesteric structure has wavelength selective reflecting properties and, due to these properties, has been used as materials for forming various optical members.

For example, JP2008-108236A discloses a pattern-printed sheet including: a substrate; and a transparent pattern having invisible light reflecting properties that is printed on a surface of the substrate, in which an ink constituting the transparent pattern includes an invisible light reflecting material, the invisible light reflecting material has wavelength selective reflecting properties in a invisible light reflecting wavelength range, in a case where a cross-section of the transparent pattern is observed with a scanning electron microscope, the cross-section has a multi-layer structure including a fixed repeating cycle, and the transparent pattern reflects only a light component which is circularly polarized in a desired rotating direction with respect to incidence light. JP2008-108236A describes that the multi-layer structure including a fixed repeating cycle is formed of a liquid crystal material having a fixed cholesteric structure. JP2008-108236A describes that, with the above-described configuration, a pattern-printed sheet which is light, inexpensive, easy to increase the area thereof, and capable of mass-production can be provided, the pattern-printed sheet being a member providing coordinate detecting means which is applicable to a data input system in which data can be handwritten directly on a screen of a display device.

JP2008-209598A describes an optical film in which an infrared or ultraviolet light absorbing layer is pattern-printed on a substrate where visible light passes and infrared or ultraviolet light is diffused and reflected. JP2008-209598A describes that the substrate where infrared or ultraviolet light is diffused and reflected is obtained by providing a curved layer on a transparent substrate and pattern-printing an infrared or ultraviolet light absorbing layer on the curved layer, the curved layer being formed of a liquid crystal material having a cholesteric structure where infrared or ultraviolet light is diffused and reflected. JP2008-209598A describes that, with the above-described configuration, an optical film which is light, inexpensive, easy to increase the area thereof, and capable of mass-production and has a wide reading angle and excellent reading performance can be provided, the optical film being a member providing coordinate detecting means which is applicable to a data input system in which data can be handwritten directly on a screen of a display device.

### SUMMARY OF THE INVENTION

However, the present inventors performed an investigation on a Signal/Noise ratio (hereinafter, also referred to as “S/N ratio”) of the material described in JP2008-108236A and JP2008-209598A and found that there is a problem in that the S/N ratio is low and the detection accuracy is not increased, the S/N ratio being a ratio of a reflectance of a wavelength selective reflection portion to a reflectance of an underlayer in a wavelength range where the wavelength selective reflection portion has selective reflecting properties. Specifically, in JP2008-108236A, only a reflection wavelength, an intensity, and circularly polarized light selectivity of a solid-coated surface for evaluation are evaluated, and there is a problem in that the SIN ratio required to detect a position is low. JP2008-209598A describes that the readable angle is improved, but there is a problem in that the S/N ratio required to detect a position is low.

An object to be achieved by the present invention is to provide an optical member having a high Signal/Noise ratio which is a ratio of a reflectance of a wavelength selective reflection portion to a reflectance of an underlayer in a wavelength range where the wavelength selective reflection portion has selective reflecting properties.

The present inventors thoroughly investigated in consideration of the above-described circumstances and found that, by providing an underlayer, which absorbs invisible light at an arbitrary wavelength, below a substrate of a wavelength selective reflection portion and providing a wavelength selective reflection portion having a cholesteric structure, which selectively reflects light at an arbitrary wavelength, on the underlayer, an intensity ratio (S/N ratio) of a reflectance of the wavelength selective reflection portion to a reflectance of the underlayer portion can be significantly increased.

Specific aspects of the present invention for achieving the above-described object and preferable ranges of the present invention are as follows.

[1] An optical member comprising a support, an underlayer, and a wavelength selective reflection portion in this order,

in which the wavelength selective reflection portion has wavelength selective reflecting properties,

the wavelength selective reflection portion has a cholesteric structure,

the cholesteric structure has a stripe pattern including bright portions and dark portions in a cross-sectional view of the wavelength selective reflection portion when observed with a scanning electron microscope,

the underlayer absorbs invisible light, and

a wavelength range where the wavelength selective reflection portion has selective reflecting properties overlaps a wavelength range of invisible light absorbed by the underlayer.

[2] In the optical member according to [1], it is preferable that the cholesteric structure includes a liquid crystal material having a cholesteric liquid crystal structure.

[3] In the optical member according to [2], it is preferable that the liquid crystal material includes a surfactant.

[4] In the optical member according to [3], it is preferable that the surfactant is a fluorine surfactant.

[5] In the optical member according to [3] or [4], it is preferable that the liquid crystal material is a material obtained by curing a liquid crystal composition including a liquid crystal compound, a chiral agent, and the surfactant.

[6] In the optical member according to any one of [1] to [5], it is preferable that a plurality of the wavelength selective reflection portions are provided in a pattern shape on a surface of the underlayer.

[7] In the optical member according to any one of [1] to [6], it is preferable that the wavelength selective reflection portion is a dot.

[8] In the optical member according to [7], it is preferable that the dot includes a portion having a height which continuously increases to a maximum height in a direction moving from an end portion of the dot to the center of the dot, and

it is preferable that, in the portion, an angle between a normal line perpendicular to a line, which is formed using a first dark portion from a surface of the dot opposite to the underlayer, and the surface is in a range of 70° to 90°.

[9] In the optical member according to [7] or [8], it is preferable that a diameter of the dot is 20 to 200 μm.

[10] In the optical member according to [7] or [8], it is preferable that a diameter of the dot is 30 to 120 μm.

[11] In the optical member according to any one of [7] to [10], it is preferable that a value obtained by dividing the maximum height by the diameter of the dot is 0.13 to 0.30.

[12] In. the optical member according to any one of [7] to [11], it is preferable that, in the end portion of the dot, an angle between the surface of the dot opposite to the underlayer and a surface of the underlayer is 27° to 62°.

[13] In the optical member according to any one of [7] to [12], it is preferable that a reflection pattern of the wavelength selective reflection portion having the pattern shape is read using an input terminal, which is capable of irradiating and detecting invisible light, so as to provide information regarding a position of the input terminal on the optical member.

[14] In the optical member according to any one of [1] to [13], it is preferable that the underlayer includes a compound having an absorption maximum at 760 nm to 1200 nm.

[15] In the optical member according to any one of [1] to [14], it is preferable that the wavelength selective reflection portion has wavelength selective reflecting properties in which a center wavelength is present in an infrared range.

[16] In the optical member according to [15], it is preferable that the wavelength selective reflection portion has wavelength selective reflecting properties in which a center wavelength is present at a wavelength of 800 to 950 nm.

[17] The optical member according to any one of [1] to [ 6] which is transparent in a visible range.

[18] An image display device comprising the optical member according to any one of [1] to [17].

According to the present invention, a new optical member is provided. In the optical member according to the present invention, a Signal/Noise ratio is high which is a ratio of a reflectance of the wavelength selective reflection portion to a reflectance of the underlayer in a wavelength range where the wave h selective reflection portion has selective reflecting properties.

### BRIEF DESCRIPTION OF THE DRAWINGS

FIG. 1 is a cross-sectional view schematically showing an example of an optical member according to the present invention.

FIG. 2 is a diagram showing images of a cross-section of a dot of an optical member prepared in Example when observed with a scanning electron microscope (SEM).

FIG. 3 is a schematic diagram showing a system in which the optical member according to the present invention is used as a sheet which is mounted on or in front of a surface of an image display device (image-displayable device).

### DESCRIPTION OF THE PREFERRED EMBODIMENTS

Hereinafter, the present invention will be described in detail.

In this specification, numerical ranges represented by “to” include numerical values before and after “to” as lower limit values and upper limit values.

In this specification, for example, unless specified otherwise, an angle such as “45°”, “parallel”, “perpendicular”, or “orthogonal” represents that a difference from an exact angle is less than 5 degrees. The difference from an exact angle is preferably less than 4 degrees and more preferably less than 3 degrees.

In this specification, “(meth)acrylate” represents “either or both of acrylate and methacrylate”.

In this specification, the meaning of “the same” includes a case where an error range is generally allowable in the technical field. In addition, in this specification, the meaning of “all”, “entire”, or “entire surface” includes not only 100% but also a case where an error range is generally allowable in the technical field, for example, 99% or more, 95% or more, or 90% or more.

Visible light refers to light which can be observed by human eyes among electromagnetic waves and refers to light in a wavelength range of 380 nm to 780 nm Invisible light refers to light in a wavelength range of shorter than 380 nm or longer than 780 nm.

Among infrared light rays, near infrared light refers to an electromagnetic wave in a wavelength range of 780 mu to 2500 nm. Ultraviolet light refers to light in a wavelength range of 10 to 380 nm.

In this specification, retroreflection refers to reflection in which light incident on an arbitrary surface is reflected in an incidence direction. Retroreflection also includes reflection where light which is incident on a surface from a normal direction perpendicular to the surface is regularly reflected (specularly reflected) in an incidence direction.

In this specification, “haze” is expressed by a value measured using a haze meter NDH-2000 (manufactured by Nippon Denshoku Industries Co., Ltd.).

Theoretically; haze refers to a value expressed by the following expression. (Diffuse Transmittance of Natural Light at 380 to 780 nm)/(Diffuse Transmittance of Natural Light at 380 to 780 nm+Direct Transmittance of Natural Light)×100%

The diffuse transmittance refers to a value calculated by subtracting the direct transmittance from a total transmittance which is obtained using a spectrophotometer and an integrating sphere unit. The direct transmittance refers to a transmittance at 0° in a case where a value measured using an integrating sphere unit is used.

[Optical Member]

The optical member according to the present invention includes a support, an underlayer, and a wavelength selective reflection portion in this order,

in which the wavelength selective reflection portion has wavelength selective reflecting properties,

the wavelength selective reflection portion has a cholesteric structure,

the cholesteric structure has a stripe pattern including bright portions and dark portions in a cross-sectional view of the wavelength selective reflection portion when observed with a scanning electron microscope,

the underlayer absorbs invisible light, and

a wavelength range where the wavelength selective reflection portion has selective reflecting properties overlaps a wavelength range of invisible light absorbed by the underlayer.

With this configuration, in the optical member according to the present invention, a Signal/Noise ratio is high which is a ratio of a reflectance of the wavelength selective reflection portion to a reflectance of the underlayer in a wavelength range where the wavelength selective reflection portion has selective reflecting properties. Although not based on any theory; the S/N ratio can be increased more than expected because the wavelength range where the wavelength selective reflection portion has selective reflecting properties overlaps the wavelength range of invisible light absorbed by the underlayer.

In this specification, the wavelength selective reflection portion and the underlayer absorbing invisible light can be distinguished from each other based on the lamination order, or based on a relationship between the heights of the reflectance of the two portions with respect to invisible light, That is, it is preferable that “the wavelength selective reflection portion” is a portion having a higher reflectance than “the underlayer absorbing invisible light” with respect to invisible light. Specifically, regarding the wavelength range where the wavelength selective reflection portion has selective reflecting properties, it is preferable that “the wavelength selective reflection portion” is a portion having a reflectance which is 1.1 times that of the underlayer absorbing invisible light (a preferable range is the same as that of a Signal Noise ratio described below which is ratio of the reflectance of the wavelength selective reflection portion to the reflectance of the underlayer).

Hereinafter, a preferable embodiment of the optical member according to the present invention will be described.

<Shape>

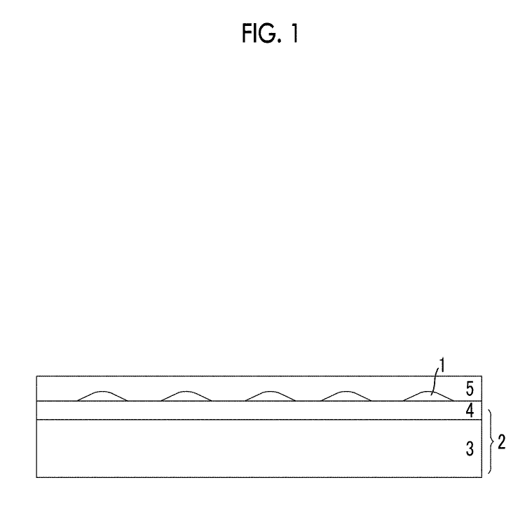

The shape of the optical member is not particularly limited and is, for example, a film shape, a sheet shape, or a plate shape. FIG. 1 is a cross-sectional view schematically showing an example of the optical member according to the present invention. The optical member shown in FIG. 1 includes: a substrate that includes a support 3 and an underlayer 4; and dot-shaped wavelength selective reflection portions 1 that are formed on a surface of the substrate 2 on the underlayer 4 side, Hereinafter, the laminate of the support and the underlayer will also be referred to as the substrate. From the viewpoint of manufacturing, it is preferable that the support and the underlayer are not integrated. However, the support and the underlayer may be integrated.

In the optical member according to the present invention, it is preferable that a plurality of the wavelength selective reflection portions are provided in a pattern shape on a surface of the underlayer, in the optical member shown in FIG. 1, a plurality of the wavelength selective reflection portions 1 are provided in a pattern shape on a surface of the underlayer 4.

In the optical member according to the present invention, it is preferable that the wavelength selective reflection portion is a dot. In the optical member shown in FIG. 1, the wavelength selective reflection portion 1 is a dot.

In the optical member shown in FIG. 1, an overcoat layer 5 is further provided on a dot-formed surface side of the substrate so as to cover the dot-shaped wavelength selective reflection portions 1. However, the overcoat layer 5 is not necessarily provided.

<Properties>

In the present invention, the S/N ratio is an intensity ratio between the reflectances in which S represents the reflectance of the wavelength selective reflection portion and N represents the reflectance of the underlayer in the wavelength range where the wavelength selective reflection portion has selective reflecting properties. The value cannot be unconditionally determined because it varies depending on the specification of an input reading device. The value is preferably 1.5 or higher and more preferably as high as possible due to its properties without limitation of the upper limit value. The S/N ratio is more preferably 2.0 or higher, still more preferably 3.0 or higher, and still more preferably 4.0 or higher.

The optical member according to the present invention may be transparent or not in the visible range depending on the application and is preferably transparent.

“Transparent” described in this specification represents that the non-polarized light transmittance (total transmittance) at a wavelength of 380 to 780 nm is preferably 50% or higher, more preferably 70% or higher, and still more preferably 85% or higher.

In the optical member according to the present invention, the upper limit of the concentration is preferably 5% or lower, more preferably 3% or lower, and still more preferably 2% or lower.

<Support>

The optical member according to the present invention includes the support.

The support included in the optical member according to the present invention functions as a substrate for forming the wavelength selective reflection portion on the surface of the underlayer.

It is preferable that the reflectance of the support is low at a wavelength where the wavelength selective reflection portion reflects light, and it is preferable that the support does not include a material which reflects light at a wavelength where the wavelength selective reflection portion reflects light.

In addition, it is preferable that the support is transparent in the visible range. In addition, the support may be colored. However, it is preferable that the support is not colored or the area of the support colored is small. Further, the refractive index of the support is preferably about 1.2 to 2.0 and more preferably about 1.4 to 1.8. The above-described configurations are made in order to prevent deterioration in the visibility of an image displayed on a display in a case where the optical member is used for, for example, a front surface of the display.

The thickness of the support may be selected depending on the application without any particular limitation, and is preferably about 5 μm to 1000 μm, more preferably 10 μm to 250 μm, and still more preferably 15 μm to 150 μm.

The support may have a single-layer structure or multi-layer structure. In a case where the support has a single-layer structure, examples thereof include glass, triacetyl cellulose (TAC), polyethylene terephthalate (PET), polycarbonates, polyvinyl chloride, acryl, and polyolefin.

<Underlayer>

The optical member according to the present invention includes at least an underlayer absorbing invisible light, in which a wavelength range where the wavelength selective reflection portion has selective reflecting properties overlaps a wavelength range of invisible light absorbed by the underlayer. In addition to the underlayer absorbing invisible light, another underlayer may be provided between the support and the underlayer absorbing invisible light or between the underlayer absorbing invisible light and the wavelength selective reflection portion.

The optical member according to the present invention includes the support, the underlayer, and the wavelength selective reflection portion in this order. Therefore, the underlayer is provided between the support and the wavelength selective reflection portion.

The underlayer is preferably a resin layer and more preferably a transparent resin layer. A binder resin component constituting the underlayer is not particularly limited, and examples of a binder resin which is preferably used in the underlayer include materials described in paragraphs “0042” and “0043” of JP2010-191146A (the content of which is incorporated herein by reference). Among these, a copolymer including benzyl (meth)acrylate and (meth)acrylic acid such as a copolymer including benzyl methacrylate and methacrylic acid is preferable.

It is preferable that a resin component constituting the underlayer is a thermosetting resin or a photocurable resin obtained by curing a composition including a polymerizable compound which is applied to a surface of the support. Examples of the polymerizable compound include a non-liquid crystal compound such as a (meth)acrylate monomer or a urethane monomer. Examples of a polymerizable compound resin which is preferably used in the underlayer include materials described in paragraphs “0044” and “0045” of JP2010-191146A (the content of which is incorporated herein by reference). Among these, a polyfunctional acrylate such as dipentaerythritol hexaacrylate (DPHA) is preferable.

The underlayer absorbing invisible light may be a layer which does not exhibit a function other than the function of absorbing invisible light or a layer which exhibits a function other than the function of absorbing invisible light. Examples of the underlayer which exhibits another function include a layer for adjusting the surface shape during the formation of a dot, a layer for improving adhesion properties with a dot, and an alignment layer for adjusting the orientation of a polymerizable liquid crystal compound during the formation of a dot.

The underlayer absorbs invisible light, preferably absorbs at least light in a wavelength range of 380 nm or shorter or in a wavelength range of longer than 780 inn, more preferably absorbs at least light in a wavelength range of longer than 780 am, still more preferably absorbs at least infrared light, and still more preferably absorbs near infrared light, and still more preferably absorbs light having a center wavelength in a wavelength range of 800 to 950 nm. The absorbance of the underlayer in the invisible range (for example, the absorbance at a wavelength of 850 am), which is the wavelength range where the wavelength selective reflection portion has selective reflecting properties, is preferably 15% or higher, more preferably 20% or higher, and still more preferably 25% or higher.

The underlayer may absorb visible light. However, it is preferable that the underlayer does not absorb visible light, that is, is transparent.

It is preferable that the reflectance of the underlayer is low at a wavelength where the wavelength selective reflection portion reflects light, and it is preferable that the underlayer does not include a material which reflects light at a wavelength where the wavelength selective reflection portion reflects light.

Further, the refractive index of the underlayer is preferably about 1.2 to 2.0 and more preferably about 1.4 to 1.8.

In the underlayer having a surface on which the wavelength selective reflection portion is formed, particularly in a case where a dot exhibiting retroreflection properties is not formed, it is preferable that the content of a fluorine surfactant, a silicone surfactant, or an acrylic acid surfactant is low. The content of the surfactant is preferably 0.001 to 1 mass %, more preferably 0.001 to 0.1 mass %, and still more preferably 0,001 to 0,05 mass % with respect to the total amount of the underlayer. Examples of a polymerizable compound resin which is preferably used in the underlayer include materials described in paragraph “0050” of JP2010-191146A (the content of which is incorporated herein by reference). Among these, a fluorine copolymer surfactant is preferable.

The thickness of the underlayer absorbing invisible light is not particularly limited and is preferably 0.01 to 50 μm and more preferably 0.05 to 20 μm.

(Infrared Absorber)

In a case where infrared light is used as the invisible light, the underlayer absorbing invisible light includes preferably an infrared absorber and more preferably a compound having an absorption maximum at 760 urn to 1200 nm.

The addition amount of the infrared absorber is typically 0.001 to 50 mass %, preferably 0.005 to 30 mass %, and still more preferably 0.01 to 10 mass % with respect to the total solid content of the underlayer absorbing invisible light. In the above-described range, an absorption intensity for realizing a high S/N ratio can be realized without adversely affecting the film hardness.

It is preferable that the infrared absorber is a dye or a pigment which absorbs infrared light.

As a dye used for the underlayer absorbing invisible light, for example, commercially available dyes or well-known dyes described in “Dye Handbook” (Journal of Synthetic Organic Chemistry, Japan; 1970) can be used. Specific examples of the dye include an azo dye, a metal complex salt azo dye, a pyrazolone azo dye, a naphthoquinone dye, an. anthraquinone dye, a phthalocyanine dye, a carbonium dye, a quinonimine dye, a methine dye, a cyanine dye, diimmonium, quaterrylene, a dithiol Ni complex, aminoanthraquinone, indoaniline, naphthalocyanine, oxonol, a pyrylium salt, and a metal thiolate complex.

Preferable examples of the dye include: cyanine dyes described in JP1983-125246A (JP-S58-125246A), JP1984-84356A (JP-S59-84356A), and JP1985-78787A (JP-S60-78787A); methine dyes described in JP1983-173696A (JP-S58-173696A), JP1983-181690A (JP-S58-181690A), and JP1983-194595A (JP-S58-194595A); naphthoquinone dyes described in JP1983-112793A(JP-S58-112793A), JP1983-224793A (JP-S58-224793A), JP1984-48187A (JP-S59-48187A), JP1984-73996A (JP-S59-73996A), JP1.985-52940A (JP-S60-52940A), and JP1985-63744A (JP-S60-63744A); squarylium dyes described in JP1983-112792A (JP-S58-112792A); and cyanine dyes described in Great Britain Patent No. 434875.

In addition, a near infrared absorption sensitizer described in U.S. Pat. No. 5,156,938A is also preferably used. In addition, arylbenzo(thio)pyrylium salts described in U.S. Pat. No. 3,881,924A, trimethinethiapyrylium salts described in JP1982-142645A (JP-S57-142645A) (corresponding to U.S. Pat. No. 4,327,169A), pyrylium compounds described in JP1983-181051A (JP-S58-18105 A), JP1983-220143A (JP-S58-220143A), JP1984-41363A (JP-S59-41363A), JP1984-84248A (JP-S59-84248A), JP1984-84249A (JP-S59-84249A), JP1984-146063A (JP-S59-146063A), and JP1984-146061A (JP-S59-146061A), cyanine colorants described in JP1984-216146A (JP-S59-216146A), pentamethinethiopyrylium salts described in U.S. Pat. No. 4,283,475A, or pyrylium compounds described in JP1993-13514B (JP-H05-13514B) and JP1993-19702B (JP-110549702B) are also preferably used. Preferable other examples of the dye include near infrared absorbing dyes represented by Formulae (I) and (II) described in U.S. Pat. No. 4,756,993A.

Other specific examples include colorants having an absorption maximum (from a different point of view, in other words, a maximum absorption wavelength) in the above-described wavelength range described in “Chemical Reviews” (1992), Vol. 92, No. 6, pp. 1197 to 1226, “Absorption Spectra of Dyes for Diode Lasers, JOEM Handbook 2” (Bunshin Publishing Co., 1990), and “Development of Infrared Absorbing Dyes for Optical Disks” (Fine Chemicals, 1999), Vol. 23, No. 3.

Specific examples include:

diimmonium colorants described in paragraphs “0072” to “0115” of JP2008-069260A;

cyanine colorants described in paragraphs “0020” to “0051” of JP2009-108267A; and

phthalocyanine colorants described in paragraphs “0010” to “0019” of JP2013-182028A.

The contents of the documents are incorporated herein by reference.

Among these dyes, for example, a cyanine colorant, a squarylium colorant, a pyrylium salt, a nickel thioiate complex, or an indolenine cyanine colorant is particularly preferable.

As the cyanine colorant, a cyanine colorant represented by the following Formula (1) is preferably used.

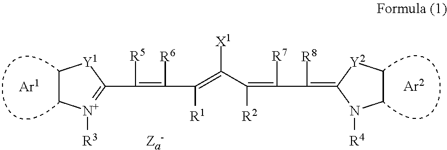

In Formula (1), X¹ represents a hydrogen atom, a halogen atom, -N(L¹)₂, X²-L¹, or a group shown below. X² represents an oxygen atom, a nitrogen atom, or a sulfur atom, and L¹ represents a hydrocarbon group having 1 to 12 carbon atoms, an aromatic ring having a heteroatom, or a hydrocarbon group having a heteroatom and 1 to 12 carbon atoms. Here, the heteroatom represents a nitrogen atom, a sulfur atom, an oxygen atom, a halogen atom, or a selenium atom. In the group shown below, Xₐ⁻ has the same definition as Zₐ⁻ described below, R³ represents a hydrogen atom or a substituent selected from the group consisting of an alkyl group, an aryl group, a substituted or unsubstituted amino group, and a halogen atom. From the viewpoint of improving visibility, it is preferable that X¹ represents —NPh₂.

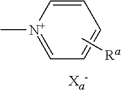

In Formula (1), R¹ and R² each independently represent a hydrogen atom or a hydrocarbon group having 1 to 12 carbon atoms. From the viewpoint of storage stability of a coating solution for an image forming layer, it is preferable that R¹ and R² represent a hydrocarbon group having 2 or more carbon atoms, and it is more preferable that R¹ and R² are bonded to each other to form a 5- or 6-membered ring. From the viewpoint of improving visibility, it is still more preferable that R¹ and R² are bonded to each other to form a 5-membered ring.

In Formula (1), Ar¹ and Ar² may be the same as or different from each other and represent an aromatic hydrocarbon group which may have a substituent. Preferable examples of the aromatic hydrocarbon group include a benzene ring group and a naphthalene ring group. Preferable examples of the substituent include a hydrocarbon group having 12 or less carbon atoms, a halogen atom, and an alkoxy group having 12 or less carbon atoms. From the viewpoint of improving visibility, the substituent is preferably an electron-donating group and more preferably an alkoxy group having 12 or less carbon atoms or an alkyl group having 12 or less carbon atoms. Y¹ and Y² may be the same as or different from each other and represent a sulfur atom or a dialkylmethylene group having 12 or less carbon atoms. R³ and R⁴ may be the same as or different from each other and represent a hydrocarbon group having 20 or less carbon atoms which may have a substituent. Preferable examples of the substituent include an alkoxy group having 12 or less carbon atoms, a carboxyl group, and a sulfo group. R⁵, R⁶, R⁷, and R⁸ may be the same as or different from each other and represent a hydrogen atom or a hydrocarbon group having 12 or less carbon atoms. From the viewpoint of raw material availability, a hydrogen atom, is preferable.

In Formula (1), Zₐ⁻ represents a counter anion. The cyanine colorant represented by Formula (1) has an anionic substituent in the structure thereof, and in a case where charge neutralization is not necessary, Zₐ⁻ is not necessary. From the viewpoint of storage stability of a coating solution for an image forming layer, the counter anion represented by Zₐ⁻ is preferably a halide ion, a perchlorate ion, a tetralluoroborate ion, a hexafluorophosphate ion, a sulfonate ion, or an organic borate ion such as a tetraphenylborate ion and more preferably a perchlorate ion, a hexafluorophosphate ion, or an arylsulfonate ion.

More preferable examples of the cyanine colorant include a colorant represented by the following Formula (2).

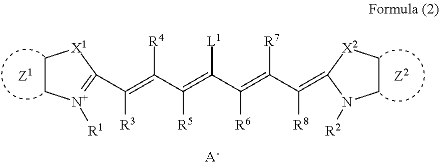

In Formula (2), LI represents a hydrogen atom, a halogen atom, —NPh₂, or —Y³-L². Y³ represents an oxygen atom, a nitrogen atom, or a sulfur atom, and L² represents an alkyl group, an aryl group, a aromatic heterocyclic group (the heteroatom represents a nitrogen atom, a sulfur atom, an oxygen atom, a halogen atom, or a selenium atom), or a hydrocarbon group having a heteroatom and 1 to 12 carbon atoms.

X¹ and X² each independently represent a sulfur atom, an oxygen atom, or a dialkylmethylene group having 12 or less carbon atoms. Z¹ and Z² each independently represent an aromatic ring group or a aromatic heterocyclic group.

R¹ and R² each independently represent a hydrocarbon group. R³, R⁴, R⁷, and R⁸ each independently represent a hydrogen atom or a hydrocarbon group having 12 or less carbon atoms. R⁵ and R⁶ each independently represent a hydrocarbon group, or R⁵ and R⁶ may be lined to each other to form a 5- or 6-membered ring. A⁻ represents a counter anion and has the same definition and the same preferable examples as Zₐ³¹ in Formula. (1) described above.

Each substituent or each ring structure may further have a substituent, and examples of the substituent which can be introduced include an alkyl group having 1 to 12 carbon atoms, an aryl group having 6 to 12 carbon atoms, a halogen atom, an alkoxy group having 1 to 12, carbon atoms, an aryloxy group having 6 to 12 carbon atoms, a hydroxyl group, an ammo group, a carbonyl group, a carboxyl group, a sulfonyl group, and a silyl group.

More preferable examples of the cyanine colorant include a colorant represented by the following Formula (3).

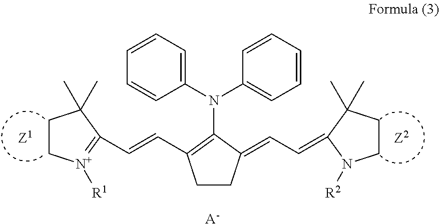

In Formula (3), Z¹ and Z² each independently represent an aromatic ring or an aromatic heterocycle. R¹ and R² each independently represent a hydrocarbon group. A³¹ represents a counter anion and has the same definition and the same preferable examples as Z in Formula (1) described above.

Each substituent or each ring structure may further have a substituent, and examples of the substituent which can be introduced include an alkyl group having 1 to 12 carbon atoms, an aryl group having 6 to 12 carbon atoms, a halogen atom, an alkoxy group having 1 to 12 carbon atoms, an aryloxy group having 6 to 12 carbon atoms, a hydroxyl group, an amino group, a carbonyl group, a carboxyl group, a sulfonyl group, and a silyl group.

Specific examples of the cyanine colorant represented by Formula (1) which can be preferably used in the present invention will be shown below, but the present invention is not limited to these examples.

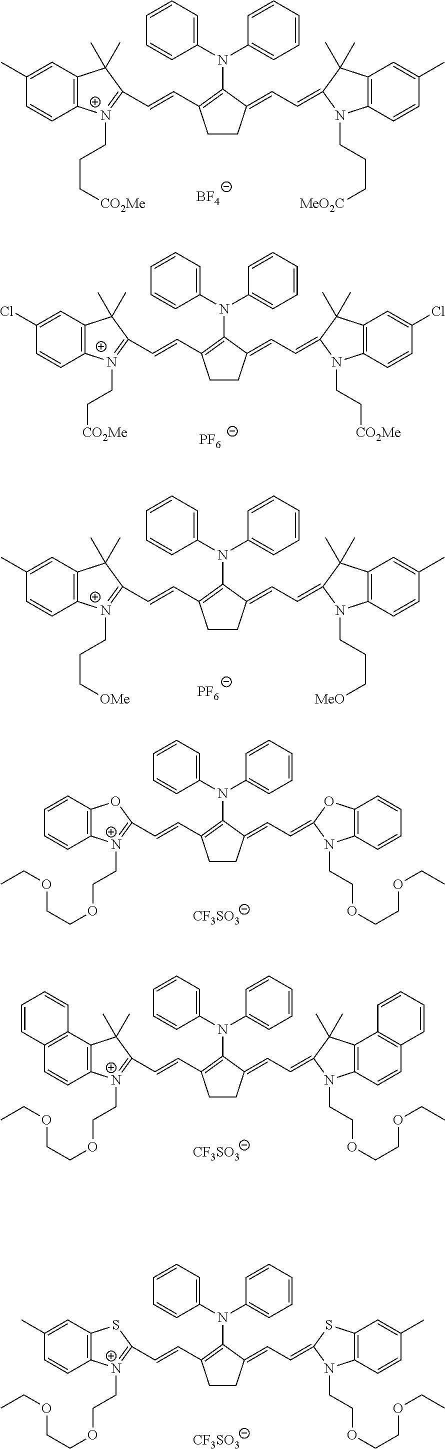

Examples of the infrared absorbing pigment which can be used in the present invention include commercially available pigments and pigments described in, for example, Color Index (C.I.) Handbook, “Recent Pigment Handbook” (edited by Japan Association of Pigment Techniques, 1977), “Recent Pigment Application Techniques” (CMC, 1986) and “Printing Ink Techniques” (CMC, 1984).

Examples of the pigment include a black pigment, a yellow pigment, an orange pigment, a brown pigment, a red pigment, a violet pigment, a blue pigment, a green pigment, a fluorescent pigment, a metal powder pigment, and a polymer binder pigment. Specifically; for example, an insoluble azo pigment, an azo lake pigment, a condensed azo pigment, a chelate azo pigment, a phthalocyanine pigment, an anthraquinone pigment, a perylene or perinone pigment, a thioindigo pigment, a quinacridone pigment, a dioxazine pigment, an isoindolinone pigment, a quinophthalone pigment, a dye lake pigment, an azine pigment, a nitroso pigment, a nitro pigment, a natural pigment, a fluorescent pigment, an inorganic pigment, or carbon black can be used.

These pigments may be surface-treated or may not be surface-treated. Examples of a surface treatment method include a method of coating a surface with a resin or a wax, a method of attaching a surfactant to a surface, and a method of bonding a reactive material (for example, a silane coupling agent, an epoxy compound, or a polyisocyanate) to a pigment surface. The details of the surface treatment method can be found in “Properties and Applications of Metal Soap” (Saiwai Shobo), “Printing Ink Techniques” (CMC, 1984), and “Recent Pigment Application Techniques” (CMC, 1986).

The particle size of the pigment is preferably in a range of 0.01 μm to 10 μm, more preferably in a range of 0.05 vim to 1 μm, and still more preferably in a range of 0.1 μm to 1 μm. In the above-described range, the stability of a pigment dispersion in a coating solution for an image forming layer is excellent, and the uniformity of the image forming layer is excellent.

As a method of dispersing the pigment, a well-known dispersing technique used for manufacturing an ink or a toner can be used. Examples of a dispersing machine include an ultrasonic disperser, a sand mill, an attritor, a pearl mill, a SUPER mill, a ball mill, an impeller, a disperser, a KD mill, a colloid mill, a DYNATRON disperser, a three-roll mill, and a pressurizing kneader. The details can be found in “Recent Pigment Application Techniques” (CMC, 1986).

(Method of Forming Underlayer)

A method of forming the underlayer is not particularly limited and can be appropriately selected depending on the purpose.

Examples of the method of forming the underlayer include a method of applying an underlayer-forming composition (which may be a solution or a dispersion) including the above-described materials of the underlayer to a surface of a lower layer such as the support using a dip coater, a die coater, a slit coater, a bar coater, or a gravure coater. Among these, a coaling method using a bar coater is preferable. In addition, it is preferable that the underlayer is formed by various printing means or by coating.

It is preferable that the underlayer-forming composition applied to a surface of a lower layer such as the support is optionally dried or heated and then cured. In a drying or heating step, the polymerizable compound in the underlayer-forming composition only has to be oriented. In the case of heating, the heating temperature is preferably 60° C. to 200° C. and more preferably 80° C. to 130° C.

The oriented polymerizable compound may be further polymerized. Regarding the polymerization, thermal polymerization or photopolymerization using light irradiation may be performed, and photopolymerization is preferable. Regarding the photopolymerization, ultraviolet light is preferably used. The irradiation energy is preferably 20 mJ/cm² to 50 mJ/cm² and more preferably 100 mJ/cm² to 1500 mJ/cm². In order to promote a photopolymerization reaction, photopolymerization may be performed under heating conditions or in a nitrogen atmosphere. The wavelength of irradiated ultraviolet light is preferably 350 nm to 430 nm. From the viewpoint of stability, the polymerization degree is preferably high, and is preferably 70% or higher and more preferably 80% or higher.

The polymerization degree can be determined by obtaining a consumption ratio between polymerizable functional groups using an infrared (IR) absorption spectrum.

<Wavelength Selective Reflection Portion

The optical member according to the present invention includes a wavelength selective reflection portion,

in which the wavelength selective reflection portion has wavelength selective reflecting properties,

the wavelength selective reflection portion has a cholestetic structure,

the cholesteric structure has a stripe pattern including bright portions and dark portions in a cross-sectional view of the wavelength selective reflection portion when observed with a scanning electron microscope, and

a wavelength range where the wavelength selective reflection portion has selective reflecting properties overlaps a wavelength range of invisible light absorbed by the underlayer.

The wavelength selective reflection portion may be formed on a single surface or both surfaces of the substrate and is preferably formed on a single surface thereof.

In the optical member according to the present invention, it is preferable that the wavelength selective reflection portion is a dot. In the following description, there will be a case where the wavelength selective reflection portion is a dot. However, in the present invention, the wavelength selective reflection portion may be a shape other than a dot.

One wavelength selective reflection portion or two or more wavelength selective reflection portions may be formed on a surface of the substrate. Two or more wavelength selective reflection portions may be provided to be adjacent to each other on the surface of the substrate such that the total surface area of the wavelength selective reflection portions is 50% or more, 60% or more, or 70% or more with respect to the area of the surface of the substrate where the wavelength selective reflection portions are formed. For example, in this case, the optical characteristics of the wavelength selective reflection portions such as selective reflecting properties may match with the optical characteristics of substantially the entire area of the optical member, in particular, the entire area of the surface where the wavelength selective reflection portions are formed. On the other hand, two or more wavelength selective reflection portions may be provided to be distant from each other on the surface of the substrate such that the total surface area of the wavelength selective reflection portions is less than 50%, 30% or less, or 10% or less with respect to the area of the surface of the substrate where the dots are formed. For example, in this case, the optical characteristics of the surface of the optical member where the wavelength selective reflection portions are formed may be recognized as a contrast between the optical characteristics of the substrate and the optical characteristics of the wavelength selective reflection portions.

In the optical member according to the present invention, it is preferable that a plurality of the wavelength selective reflection portions (preferably dots) are provided in a pattern shape on a surface of the underlayer. A plurality of wavelength selective reflection portions are formed in a pattern shape and may have a function of presenting information. For example, by forming the wavelength selective reflection portions so as to provide position information on an optical member which is formed in a sheet shape, the optical member can be can be used as a sheet which can be mounted on a display and is capable of inputting data.

In a case where the wavelength selective reflection portions are formed in a pattern shape, for example, a plurality of dots having a diameter of 20 to 200 μm are formed, 10 to 100 dots, preferably 15 to 50 dots, and more preferably 20 to 40 dots are provided on average in a square having a size of 2 mm×2 mm on the substrate surface.

In a case where a plurality of wavelength selective reflection portions are provided on a surface of the substrate, the wavelength selective reflection portion may have the same diameter and shape or different diameters and shapes and preferably has the same diameter and shape. For example, it is preferable that the wavelength selective reflection portions are formed under the same conditions for forming the wavelength selective reflection portions having the same diameter and shape.

In this specification, the description of the wavelength selective reflection portion is applicable to all the wavelength selective reflection portions in the optical member according to the present invention. Further, it is allowable that the optical member according to the present invention including the above-described wavelength selective reflection portions also includes a wavelength selective reflection portion which deviates from the above description due to an error which is allowable in the technical field.

(Shape of Wavelength Selective Reflection Portion)

As a shape of the wavelength selective reflection portion other than a dot, for example, a well-known shape as an infrared reflection pattern, and examples thereof include a bar code shape, a two-dimensional bar code shape, a pattern shape of a combination of sizes of overlapping portions of horizontally and vertically disposed ruled lines in a predetermined shape which is obtained by changing the thicknesses of the ruled lines, an arbitrary character shape, and a number shape.

In a case where the wavelength selective reflection portions are dots, the dot shape is not particularly limited as long as adjacent dots can be easily distinguished from each other. Typically, the dot shape is, for example, a circular shape, an elliptical shape, or a polygonal shape. In addition, the three-dimensional shape of the dot is not particularly limited and is typically a disk shape. However, the three-dimensional shape of the dot may be a hemispherical shape or a concave shape. It is preferable that the dot is circular when observed from a normal direction perpendicular to the substrate. The circular shape is not necessarily a perfect circle and may be a substantially circular shape. The center of the dot described herein refers to the center of the circle or the center of gravity. In a case where a plurality of dots are provided on a surface of the substrate, it is preferable that the average shape of the dots is circular, and some dots may have a shape other than a circular shape.

The diameter of the dot film is preferably 20 to 200 μm and more preferably 30 μm to 120 μm.

The diameter of the dot can be obtained by measuring the length of a line, which ranges from an end portion (an edge or a boundary of the dot) to another end portion and passes through the center of the dot, in an image obtained using a microscope such as a laser microscope, a scanning electron microscope (SEM), or a transmission electron microscope (TEM). The number of dots and the distance between dots can be obtained from a microscopic image obtained using a laser microscope, a scanning electron microscope (SEM), or a transmission electron microscope (TEM).

The dot includes a portion having a height which continuously increases to a maximum height in a direction roving from an end portion of the dot to the center of the dot. That is, the dot includes an inclined portion, a curved portion, or the like whose height increases from an end portion of the dot to the center of the dot. In this specification, the above portion will also be referred to as the inclined portion or the curved portion. The inclined portion or the curved portion refers to a portion of a dot surface in a cross-sectional view, the portion being surrounded by a portion of the dot surface which ranges from a continuous increasing start point to a maximum height point, a straight line which connects the points to the substrate at the shortest distance, and the substrate.

“The height” of the dot described in this specification refers to “the shortest distance from a point of a surface of the dot opposite to the substrate to a surface of the substrate where the dot is formed”. At this time, the surface of the dot may be an interface with another layer. In addition, in a ease where the substrate has convex and concave portions, a surface of an end portion of the dot extending from the substrate is set as the surface where the dot is formed. The maximum height refers to a maximum value of the height which is, for example, the shortest distance from the peak of the dot to the surface of the substrate where the dot is formed. The height of the dot can be obtained from a cross-sectional view of the dot which is obtained by focal position scanning using a laser microscope or obtained using a microscope such as a SEM or a TEM.

The inclined portion or the curved portion may be present at end portions in some or all the directions when seen from the center of the dot. For example, in a case where the dot is circular, end portions correspond to the circumference, and the inclined portion or the curved portion may be present at end portions in some directions of the circumference (for example, portions corresponding to a length of 30% or more, 50% or more, or 70% or more and 90% or less of the circumference), or may be present at end portions in all the directions of the circumference (90% or more, 95% or more, or 99% or more of the circumference). It is preferable that the end portions of the dot may be present in all the directions of the circumference. That is, it is preferable that changes in height from the center of the dot to the circumference are the same in all the directions of the circumference. In addition, it is preferable that optical characteristics such as retroreflection properties and properties described regarding the cross-sectional view are the same in. all the directions moving from the center to the circumference.

The inclined portion or the curved portion may be at a predetermined distance from an end portion of the dot (an edge or a boundary of the circumference) so as not to reach the center of the dot, or may reach the center of the dot from an end portion of the dot. In addition, the inclined portion or the curved portion may be at a predetermined distance from a portion, which is at a predetermined distance from an edge (boundary) of the circumference of the dot, so as not to reach the center of the dot, or may reach the center of the dot from a portion which is at a predetermined distance from an end portion of the circumference of the dot.

Examples of a shape of a structure including the inclined portion or the curved portion includes a hemispherical shape in which the substrate side is planar, a shape (spherical segment shape) in which the top of the hemispherical shape is cut and smoothened to be substantially parallel to the substrate, a conical shape having a bottom on the substrate side, and a shape (truncated conical shape) in which the top of the conical shape is cut and smoothened to be substantially parallel to the substrate. Among these shapes, a hemispherical shape in which the substrate side is planar, a shape in which the top of the hemispherical shape is cut and smoothened to be substantially parallel to the substrate, or a shape in which the top of a conical shape having a bottom on the substrate side is cut and smoothened to be substantially parallel to the substrate is preferable. The hemispherical shape represents not only a hemispherical shape in which a surface including the center of a sphere is planar but also any one of spherical segment shapes obtained by cutting a sphere into two segments at an arbitrary position (preferably a spherical segment shape not including the center of the sphere).

A point of the dot surface for obtaining the maximum height of the dot may be present at the peak of a hemispherical shape or a conical shape or may be present on a surface which is cut and smoothened to be substantially parallel to the substrate. It is preferable that the maximum height of the dot is obtained at all the points of the smooth surface. It is also preferable that the maximum height is obtained at the center of the dot.

It is preferable that a value (maximum height/diameter) obtained by dividing the maximum height by the diameter of the dot is 0.13 to 0.30. It is preferable that the above-described condition is satisfied particularly in a shape in which the height of the dot continuously increases to the maximum height from an end portion of the dot and in which the maximum height is obtained at the center of the dot, for example, a hemispherical shape in which the substrate side is planar, a shape in which the top of the hemispherical shape is cut and flattened to be substantially parallel to the substrate, or a shape in which the top of a conical shape having a bottom on the substrate side is cut and flattened to be substantially parallel to the substrate. The ratio maximum height/diameter is more preferably 0.16 to 0.28.

In addition, an angle (for example, an average value) between a surface of the dot opposite to the substrate and the substrate (surface of the substrate where the dot is formed) is preferably 27° to 62° and more preferably 29° to 60°. By setting the angle in the above-described range, the dot can be made to exhibit high retroreflection properties at a light incidence angle which is suitable for the applications of the optical member described below.

The angle can be obtained from a cross-sectional view of the dot which is obtained by focal position scanning using a laser microscope or obtained using a microscope such as a SEM or a TEM. In this specification, in a SEM image of a cross-sectional view of a surface of the dot perpendicular to the substrate including to the center of the dot, the angle of a contact portion between the substrate and the dot surface is measured.

(Optical Characteristics of Wavelength Selective Reflection Portion)

The wavelength selective reflection portion has wavelength selective reflecting properties. Light to which the wavelength selective reflection portion exhibits selective reflecting properties is not particularly limited as long as a wavelength range where the wavelength selective reflection portion has selective reflecting properties overlaps a wavelength range of invisible light absorbed by the underlayer. For example, any one of infrared light, visible light, and ultraviolet light may be used. For example, in a case where the optical member is attached to a display device and is used for directly handwriting data on the display device to input data, the light to which the wavelength selective reflection portion exhibits selective reflecting properties is preferably invisible light, more preferably infrared light, and still more preferably near infrared light in order not to adversely affect a display image. In the optical member according to the present invention, for example, in a spectrum of reflection from the wavelength selective reflection portion, it is preferable that the wavelength selective reflection portion has wavelength selective reflecting properties in which a center wavelength is present in an infrared range, it is more preferable that the wavelength selective reflection portion has wavelength selective reflecting properties in which a center wavelength is present in an near infrared range, it is still more preferable that the wavelength selective reflection portion has wavelength selective reflecting properties in which a center wavelength is present in a wavelength range of 750 to 2000 nm, it is still more preferable that the wavelength selective reflection portion has wavelength selective reflecting properties in which a center wavelength is present in a wavelength range of 800 to 1500 nm, and it is still more preferable that the wavelength selective reflection portion has wavelength. selective reflecting properties in which a center wavelength is present in a wavelength range of 800 to 950 nm. It is also preferable that the reflection wavelength is selected based on a wavelength of light emitted from a light source which is used in combination or a wavelength of light which is detected by a image pickup element (sensor).

It is preferable that the wavelength selective reflection portion has a cholesteric structure and includes a liquid crystal material having a cholesteric liquid crystal structure, and it. is more preferable that the wavelength selective reflection portion is formed of a liquid crystal material having a cholesteric liquid crystal structure. The wavelength of light where the wavelength selective reflection portion exhibits selective reflecting properties can be adjusted by adjusting a helical pitch in the cholesteric structure which forms the wavelength selective reflection portion as described above. In addition, in a preferable embodiment of the present invention, regarding a material for forming the wavelength selective reflection portion in the optical member according to the present invention, it is preferable that a helical axis direction of the cholesteric structure is controlled as described below, and it is more preferable that retroreflection properties to light incident from various directions are high.

It is preferable that the wavelength selective reflection portion is transparent in the visible range. In addition, the wavelength selective reflection portion may be colored. However, it is preferable that the wavelength selective reflection portion is not colored or the area of the wavelength selective reflection portion colored is small. The above-described configurations are made in order to prevent deterioration in the visibility of an image displayed on a display in a case where the optical member is used for, for example, a front surface of the display.

(Cholesteric Structure)

It is known that the cholesteric structure exhibits selective reflecting properties at a specific wavelength. A center wavelength of the selective reflection depends on a pitch P (=helical cycle) of a helical structure in the cholesteric structure and complies with an average refractive index n of a cholesteric liquid crystal and a relationship of λ=n×P. Therefore, the selective reflection wavelength can be adjusted by adjusting the pitch of the helical structure. The pitch of the cholesteric structure depends on the kind of a chiral agent which is used in combination of a polymerizable liquid crystal compound during the formation of the wavelength selective reflection portion, or the concentration of the chiral agent added. Therefore, a desired pitch can be obtained by adjusting the kind and concentration of the chiral agent. The details of the adjustment of the pitch can be found in “Fuji Film Research&Development” No. 50 (2005), pp. 60 to 63. As a method of measuring a helical sense or pitch, a method described in “Introduction to Experimental Liquid Crystal Chemistry”, (the Japanese Liquid Crystal Society, 2007, Sigma Publishing Co., Ltd.), p. 46, and “Liquid Crystal Handbook” (the Editing Committee of Liquid Crystal Handbook, Maruzen Publishing Co., Ltd.), p. 196 can be used.

The cholesteric structure has a stripe pattern including bright portions and dark portions in a cross-sectional view of the wavelength selective reflection portion when observed with a scanning electron microscope (SEM). Two cycles of the bright portion and the dark portion (two bright portions and two dark portions)correspond to one helical pitch. Based on the above fact, the pitch can be measured from the SEM cross-sectional view. A normal line perpendicular to each line of the stripe pattern is a helical axis direction.

Reflected light of the cholesteric structure is circularly polarized light. That is, reflected light of the wavelength selective reflection portion in the optical member according to the present invention is circularly polarized light. The application of the optical member according to the present invention can be selected in consideration of the circularly polarized light selective reflecting properties. Whether or not the reflected light of the cholesteric structure is right circularly polarized light or left circularly polarized light is determined depending on a helical twisting direction. For example, regarding the selective reflection by the cholesteric liquid crystals, in a case where the helical twisting direction of the cholesteric liquid crystals is right, right circularly polarized light is reflected, and in a case where the helical twisting direction of the cholesteric liquid crystals is left, left circularly polarized light is reflected.

In addition, a full width at half maximum Δλ (nm) of a selective reflection bandwidth (circularly polarized light reflection bandwidth) depends on a birefringence Δn of the liquid crystal compound and the pitch P and complies with a relationship of Δλ=Δn×P. Therefore, the selective reflection bandwidth can be controlled by adjusting Δn. An can be adjusted by adjusting the kind of the polymerizable liquid crystal compound and a mixing ratio thereof, or by controlling a temperature during oriented immobilization. The full width at half maximum of the reflection wavelength range is adjusted depending on the application of the optical member according to the present invention and is, for example, 50 to 500 nm and preferably 100 to 300 nm.

(Cholesteric Structure in Dot)

In a case where the inclined portion or the curved portion in the dot is observed in a cross-sectional view using a scanning electron microscope (SEM), it is preferable that an angle between a normal line perpendicular to a line, which is formed using a first dark portion from a surface of the dot opposite to the substrate, and the surface is in a range of 70° to 90°. At this time, regarding all the points of the inclined portion or the curved portion, it is preferable that an angle between a normal direction perpendicular to a line, which is formed using a first dark portion from a surface of the dot opposite to the substrate, and the surface is in a range of 70° to 90°. That is, the angle only has to satisfy the above-described range at some points of the inclined portion or the curved portion. For example, the angle only has to satisfy the above-described range not intermittently but continuously at sonic points of the inclined portion or the curved portion. In a case where the surface in the cross-sectional view is curved, an angle between the normal line and the curved surface refers to an angle between the normal line and a tangent line from the surface. in addition, the angle between the normal line and the surface is expressed by an acute angle and is in a range of 70° to 110° when expressed by an angle of 0° to 180°. In the cross-sectional view, it is preferable that an angle between a normal line perpendicular to each of lines, which are formed using first and second dark portions from a surface of the dot opposite to the substrate, and the surface is in a range of 70° to 90°, it is more preferable that an angle between a normal line perpendicular to each of lines, which are formed using first to third or fourth dark portions from a surface of the dot opposite to the substrate, and the surface is in a range of 70° to 90°, and it is still more preferable that an angle between a normal line perpendicular to each of lines, which are formed using first to fifth to twelfth or more dark portions from a surface of the dot opposite to the substrate, and the surface is in a range of 70° to 90°.

The angle is preferably in a range of 80° to 90° and More preferably in a range of 85° to 90°.

The cross-sectional view obtained using the SEM shows that an helical axis of the cholesteric structure forms an angle of 70° to 90° with a surface of the dot of the inclined portion or the curved portion. Due to the above-described structure, light incident on the dot in a direction with an angle from a normal direction perpendicular to the substrate can be made to be incident at an angle, which is substantially parallel to the helical axis direction of the cholesteric structure, at the inclined portion or the curved portion. Therefore, the dot can exhibit high retroreflection properties with respect to light incident from various directions with an angle from the normal direction perpendicular to the substrate. For example, depending on the shape of the dot, the dot can exhibit high retroreflection properties with respect to light incident from a direction with an angle (in this specification, also referred to as “polar angle”) of 60° to 0° from the normal line perpendicular to the substrate. It is more preferable that the dot can exhibit high retroreflection properties with respect to light incident from a direction with a polar angle of 45° to 0°.

It is preferable that, by making an helical axis of the cholesteric structure to form an angle of 70° to 90° with a surface of the dot of the inclined portion or the curved portion, an angle between a normal direction perpendicular to a line, which is formed using a first dark portion from the surface, and a normal direction perpendicular to the substrate continuously decreases along with a continuous increase in the height.

The cross-sectional view is a cross-sectional view of a surface in an arbitrary direction including a portion having a height which continuously increases to a maximum height in a direction moving from an end portion of the dot to the center of the dot. Typically, the cross-sectional view may be a cross-sectional view of an arbitrary surface which includes the center of the dot and is perpendicular to the substrate.

(Method of Forming Cholesteric Structure)

It is preferable that the cholesteric structure is a structure in which a cholesteric liquid crystal phase is immobilized. The cholesteric structure can be obtained by immobilizing a cholesteric liquid crystal phase. The structure in which a cholesteric liquid crystal phase is immobilized may be a structure in which the orientation of the liquid crystal compound as a cholesteric liquid crystal phase is immobilized. Typically, the structure in which a cholesteric liquid crystal phase is immobilized may be a structure which is obtained by making the polymerizable liquid crystal compound to be in a state where a cholesteric liquid crystal phase is oriented, polymerizing and curing the polymerizable liquid crystal compound with ultraviolet irradiation, heating, or the like to form a layer having no fluidity, and concurrently changing the state of the polymerizable liquid crystal compound into a state where the oriented state is not changed by an external field or an external force. The structure in which a cholesteric liquid crystal phase is immobilized is not particularly limited as long as the optical characteristics of the cholesteric liquid crystal phase are maintained, and the liquid crystal compound does not necessarily exhibit liquid crystallinity. For example, the molecular weight of the polymerizable liquid crystal compound may be increased by a curing reaction such that the liquid crystallinity thereof is lost.

Material

Examples of a material used for forming the cholesteric structure include a liquid crystal composition including a liquid crystal compound. Among these a liquid crystal composition including a polymerizable liquid crystal compound is preferable.

It is preferable that the liquid crystal composition including a polymerizable liquid crystal compound further includes a surfactant. The liquid crystal composition may further include a chiral agent and a polymerization initiator.

Liquid Crystal Compound

It is preferable that the liquid crystal compound is a polymerizable liquid crystal compound.

The liquid crystal compound may be a rod-shaped liquid crystal compound or a disk-shaped liquid crystal compound and is preferably a rod-shaped liquid crystal compound.

Examples of the rod-shaped polymerizable liquid crystal compound for forming a cholesteric liquid crystal layer include a rod-shaped nematic liquid crystal compound. As the rod-shaped nematic liquid crystal compound, an azotnethine compound, an azoxy compound, a cyanophenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolan compound, or an alkenylcyclohexylbenzonitrile compound is preferably used. Not only a low-molecular-weight liquid crystal compound but also a high-molecular-weight liquid crystal compound can be used.

The polymerizable liquid crystal compound can be obtained by introducing a polymerizable group into the liquid crystal compound. Examples of the polymerizable group include an unsaturated polymerizable group, an epoxy group, and an aziridinyl group. Among these, an unsaturated polymerizable group is preferable, and an ethylenically unsaturated polymerizable group is more preferable. The polymerizable group can be introduced into the molecules of the liquid crystal compound using various methods. The number of polymerizable groups in the polymerizable liquid crystal compound is preferably 1 to 6 and more preferably 1 to 3. Examples of the polymerizable liquid crystal compound include compounds described in Makromol. Chem. (1989), Vol. 190, p. 2255, Advanced Materials (1993), Vol. 5, p. 107, U.S. Pat. No. 4,683,327A, U.S. Pat. No. 5,622,648A, U.S. Pat. No. 5,770,107A, WO95/22586, WO95/24455, WO97/00600, WO98/23580, WO98/52905, JP1989-272551A (JP-H1-272551A), JP1994-16616A (JP-H6-16616A), JP1995-110469A (JP-H7-110469A), JP1999-80081A (JP-H11-80081A), and JP2001-328973A. Two or more polymerizable liquid crystal compounds may be used in combination. In a case where two or more polymerizable liquid crystal compounds are used in combination, the orientation temperature can be decreased.

Examples of a nematic liquid crystal molecule (liquid crystal monomer) which can be used in the present invention include a compound represented by any one of the following formulae (1) to (11). The compound described herein has an acrylate structure and is polymerizable with ultraviolet irradiation or the like.

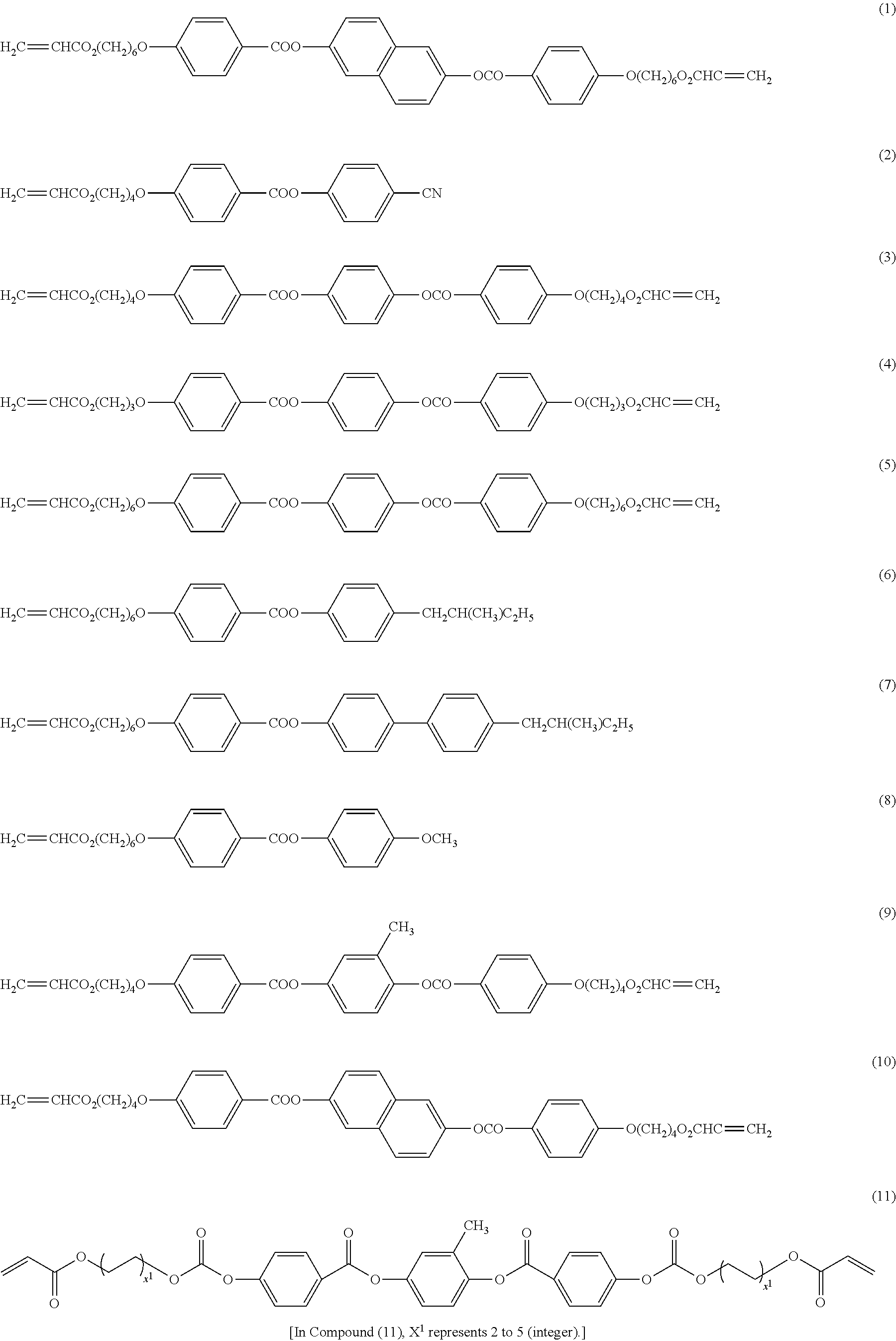

In addition, as the polymerizable oligomer, for example, a cyclic organopolysiloxane compound having a cholesteric phase described in JP 1982-165480A (JP-S57-165480A) can be used.

Further, as the liquid crystal polymer, for example, a polymer in which a liquid crystal mesogenic group is introduced into a main chain, a side chain, or both a main chain and a side chain, a polymer cholesteric liquid crystal in which a cholesteryl group is introduced into a side chain, a liquid crystal polymer described in JP1997-133810A (JP-H9-133810A), and a liquid crystal polymer described in JP1999-293252A (JP-H11-293252A) can be used.

In addition, the addition amount of the polymerizable liquid crystal compound in the liquid crystal composition is preferably 75 to 99.9 mass %, more preferably 80 to 99 mass %, and still more preferably 85 to 90 mass % with respect to the solid content mass (mass excluding a solvent) of the liquid crystal composition.

Surfactant

The present inventors found that, by adding the surfactant to the liquid crystal composition during the formation of a dot, the polymerizable liquid crystal compound is oriented to be parallel to an air interface side, and the helical axis direction of the dot is controlled as described above. In general, for the formation of a dot, it is necessary that the surface tension is not decreased to maintain a liquid drop shape during printing. Therefore, it is surprising that a dot can be formed even after the addition of the surfactant and that the dot exhibits high retroreflection properties in multiple directions. Examples described below shows that, in the optical member according to the present invention in which the surfactant was used, an angle between a dot surface and the substrate at a dot end portion was 27° to 62°. That is, it can be seen that, in the optical member according to the present invention, at dot shape can be obtained in which high retroreflection properties at an incidence angle of light required for use in an input medium, which is used in combination with input means such as an electronic pen, are exhibited.

It is preferable that the surfactant is a compound which can function as an orientation controller contributing to the stable or rapid formation of a cholesteric structure with planar orientation. Examples of the surfactant include a silicone surfactant and a fluorine surfactant. Among these, a fluorine surfactant is preferable.

Specific examples of the surfactant include compounds described in paragraphs “0082” to “0090” of JP2014-119605A, compounds described in paragraphs “0031” to “0034” of JP2012-203237A, exemplary compounds described in paragraphs “0092” and “0093” of JP2005-99248A, exemplary compounds described in paragraphs “0076” to “0078” and “0082” to “0085” of 22002-129162A, and fluorine (meth)acrylate described in paragraphs “0018” to “0043” of JP2007-272185A.

As a horizontal orientation agent, one kind may be used alone, or two or more kinds may be used in combination.

Examples of the fluorine surfactant include a compound represented by the following Formula (I) described in paragraphs “0082” to “0090” of JP2014-119605A.

(Hb¹¹-Sp¹¹-L¹¹-Sp¹²-L¹²)ₘ₁₁-A¹¹-L¹³-T¹¹-L¹⁴-A¹²-(L¹⁵-Sp¹³-L¹⁶-Sp¹⁴-Hb¹¹)ₙ₁₁ Formula (I)

In Formula (I), L ¹¹, L¹², L¹³, L¹⁴, L¹⁵, and L¹⁶ each independently represent a single bond, —O—, —S—, —CO—, —COO—, —OCO—, —COS—, —SCO—, —NRCO—, or —CONR— (in Formula (I), R represents a hydrogen atom or an alkyl group having 1 to 6 carbon atoms). —NRCO— or —CONR— has an effect of reducing solubility and is likely to increase haze during the preparation of the wavelength selective reflection portion. From this viewpoint, —O—, —S—, —CO—, —COO—, —OCO—, —COS— or —SCO— is more preferable. From the viewpoint of the stability of the compound, —O—, —CO—, —COO—, or —OCO— is more preferable. An alkyl group represented by R may be linear or branched. An alkyl group having 1 to 3 carbon atoms is more preferable, and examples thereof include a methyl group, an ethyl group, and an n-propyl group.

Sp¹¹, Sp¹², Sp¹³, and Sp¹⁴ each independently represent a single bond or an alkylene group having 1 to 10 carbon atoms, more preferably a single bond or an alkylene group having 1 to 7 carbon atoms, and still more preferably a single bond or an alkylene group having 1 to 4 carbon atoms. However, a hydrogen atom in the alkylene group may be substituted with a fluorine atom. The alkylene group may have a branch or not, and a linear alkylene group having no branch is preferable. From the viewpoint of synthesis, it is preferable that Sp¹¹ and Sp¹⁴ are the same and Sp¹² and Sp¹³ are the same.

A¹¹ and A¹² represent a monovalent to tetravalent aromatic hydrocarbon group. The number of carbon atoms in the aromatic hydrocarbon group is preferably 6 to 22, more preferably 6 to 14, still more preferably 6 to 10, and still more preferably 6. The aromatic hydrocarbon group represented by A¹¹ or A¹² may have a substituent. Examples of the substituent include an alkyl group having 1 to 8 carbon atoms, an alkoxy group, a halogen atom, a cyano group, and an ester group. The description and preferable ranges of the groups can be found in the corresponding description of T described below, Examples of a substituent with which the aromatic hydrocarbon group represented by A¹¹ or A¹² is substituted include a methyl group, an ethyl group, a methoxy group, an ethoxy group, a bromine atom, a chlorine atom, and a cyano group. A molecule including a large amount of a perfluoroalkyl portion can cause liquid crystal to be oriented even in a small addition amount, which leads to reduction in haze. Therefore, in order for the molecule to include many perfluoroalkyl groups, it is preferable that A¹¹ and A¹² are tetravalent. From the viewpoint of synthesis, it is preferable that A¹¹ and A¹² are the same.

T¹¹ represents a divalent group or a divalent aromatic heterocyclic group preferably represented by any one of the following formulae (X in T¹¹ represents an alkyl group having 1 to 8 carbon atoms, an alkoxy group, a halogen atom, a cyano group, or an ester group, and Ya, Yb, Yc, and Yd each independently represent a hydrogen atom or an alkyl group having 1 to 4 carbon atoms),

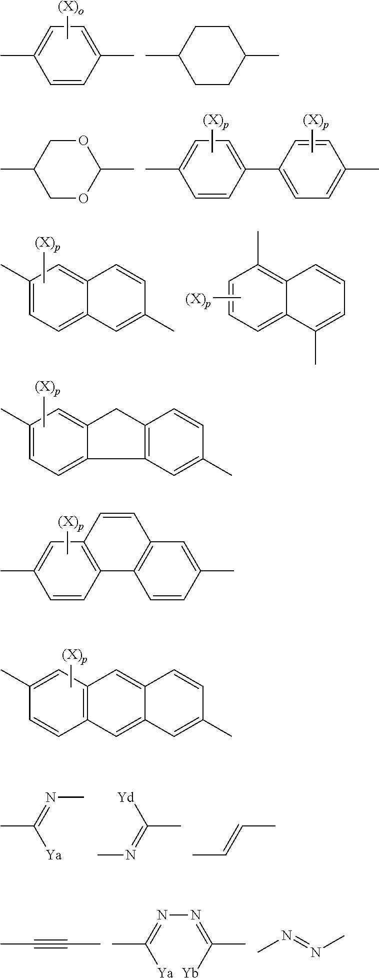

more preferably represented by any one of the following formulae,

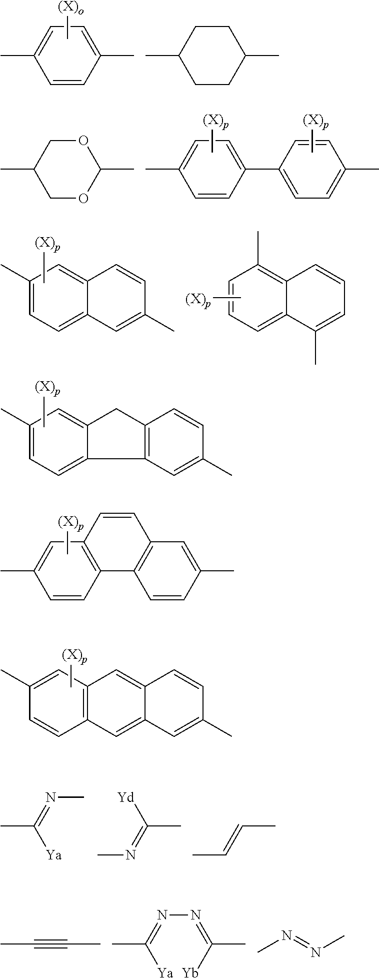

still more preferably represented by any one of the following formulae, and

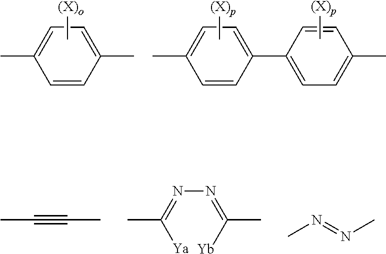

still more preferably represented by the following formula.

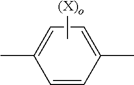

The number of carbon atoms in the alkyl group represented by X in T¹¹ is 1 to 8, preferably 1 to 5, and more preferably 1 to 3. The alkylene group may be linear, branched, or cyclic and is preferably linear or branched. Preferable examples of the alkyl group include a methyl group, an ethyl group, an n-propyl group, and an isopropyl group. Among these, a methyl group is preferable. The details of an alkyl portion of the alkoxy group represented by X in T¹¹ can be found in the description and preferable range of the alkyl group represented by X in T¹¹. Examples of the halogen atom represented by X in T¹¹ include a fluorine atom, a chlorine atom, a bromine atom, and an iodine atom. Among these, a chlorine atom or a bromine atom is preferable. Examples of the ester group represented by X in include a group represented by R′COO—, R′ represents, for example, an alkyl group having 1 to 8 carbon atoms. The description and preferable range of the alkyl group represented by R′ can be found in the description and preferable range of the alkyl group represented by X in T¹¹. Specific examples of the ester include CH₃COO— and C₂H₅COO—. The alkyl group having 1 to 4 carbon atoms represented by Ya, Yb, Yc, or Yd may be linear or branched. Examples of the alkyl group having 1 to 4 carbon atoms include a methyl group, an ethyl group, an n-propyl group, and an isopropyl group.

It is preferable that the divalent aromatic heterocyclic group has a 5-membered, 6-membered, or 7-membered heterocycle. A 5-membered or 6-membered heterocycle is more preferable, and a 6-membered heterocycle is most preferable. As a heteroatom constituting the heterocycle, a nitrogen atom, an oxygen atom, or a sulfur atom is preferable. It is preferable that the heterocycle is an aromatic heterocycle. In general, the aromatic heterocycle is an unsaturated heterocycle. An unsaturated heterocycle having most double bonds is more preferable. Examples of the heterocycle include a furan ring, a thiophene ring, a pyrrole ring, a pyrroline ring, a pyrrolidine ring, an oxazole ring, an isoxazole ring, a thiazole ring, an isothiazole ring, an imidazole ring, an imidazoline ring, an imidazolidine ring, a pyrazole ring, a pyrazoline ring, a pyrazolidine ring, a triazole ring, a furazan ring, a tetrazole ring, a pyran ring, a thiin ring, a pyridine ring, a piperidine ring, an oxazine ring, a morpholine ring, a thiazine ring, a pyridazine ring, a pyrimidine ring, a pyrazine ring, a piperazine ring, and a triazine ring. The divalent heterocyclic group may have a substituent. The description and preferable range of the substituent can be found in the description of the substituent with which the monovalent to tetravalent aromatic hydrocarbon represented by A¹ or A² is substituted.

Hb¹¹ represents a perfluoroalkyl group having 2 to 30 carbon atoms, more preferably a perfluoroalkyl group having 3 to 20 carbon atoms, and still more preferably a perfluoroalkyl group having 3 to 10 carbon atoms. The perfluoroalkyl group may be linear, branched, or cyclic and is preferably linear or branched and more preferably linear,

m11 and n11 each independently represent 0 to 3 and m11+n11≧1. At this time, a plurality of structures in parentheses may be the same as or different from each other and is preferably the same as each other. m11 and n11 in Formula (I) are determined depending on the valences of A¹¹ and A¹², and preferable ranges thereof are determined depending on the preferable ranges of the valences of A¹¹ and A¹².

o and p in T¹¹ each independently represent an integer of 0 or more. In a case where o and p represent an integer of 2 or more, a plurality of X's may be the same as or different from each other. o in T¹¹ represents preferably 1 or 2. p in T¹¹ represents preferably an integer of 1 to 4 and more preferably 1 to 2.

A molecular structure of the compound represented by Formula (I) may be symmetrical or non-symmetrical. “Symmetry” described herein represents at least one of point symmetry line symmetry, or rotational symmetry, and “non-symmetry” described herein does not represent any one of point symmetry, line symmetry, and rotational symmetry.

The compound represented by Formula (I) is a combination of the perfluoroalkyl group (Hb¹¹), the linking groups -(Sp¹¹-L¹¹-Sp¹²-L¹²)m₁₁-A¹¹-L¹³- and -L¹⁴-A¹²-(L¹⁵-Sp¹³-L¹⁶-Sp¹⁴)ₙ₁₁, and preferably the divalent group having an excluded volume effect which is represented by T. Two perfluoroalkyl groups (Hb¹¹) present in the molecule are preferably the same as each other, and the linking groups -(-Sp¹¹-L¹¹-Sp¹²-L¹²)m₁₁-A¹¹-L¹³- and and -L¹⁴-A¹²-(L¹⁵-Sp¹³-L¹⁶-Sp¹⁴)ₙ₁₁- present in the molecule are also preferably the same as each other. Hb¹¹-Sp¹¹-L¹¹-Sp¹²- and -Sp¹³-L¹⁶-Sp¹⁴-Hb¹¹ present at the terminal are preferably a group represented by any one of the following formulae:

(CₐF₂ₐ₊₁)—(C_{b}H_{2b})—;

(CₐF₂ₐ₊₁)—(C_{b}H_{2b})—O—(CᵣH₂ᵣ)—;

(CₐF₂ₐ₊₁)—(C_{b}H_{2b})—COO—(CᵣH₂ᵣ)—; and

(CaₐF₂ₐ₊₁)—(C_{b}H_{2b})—OCO—(CᵣH₂ᵣ)—.

In the above formulae, a represents preferably 2 to 30, more preferably 3 to 20, and still more preferably 3 to 10. b represents preferably 0 to 20, more preferably 0 to 10, and still more preferably 0 to 5. a+b represents 3 to 30. r represents preferably 1 to 10 and more preferably 1 to 4.

In addition, Hb¹¹-Sp¹¹-L¹¹-Sp¹²-L¹² and L¹⁵-Sp¹³-L¹⁶-Sp¹⁴-Hb¹¹ present at the terminal of Formula (I) are preferably a group represented by any one of the following formulae:

(CₐF₂ₐ₊₁)—(C_{b}H_{2b})—O—;

(CₐF₂ₐ₊₁)—(C_{b}H_{2b})—COO—;

(CₐF₂ₐ₊₁)—(C_{b}H_{2b})—O—(CᵣH₂ᵣ)—O—.

(CₐF₂ₐ₊₁)—(C_{b}H_{2b})—COO—(CᵣH₂ᵣ)—COO—; and

(CₐF₂ₐ₊₁)—(C_{b}H_{2b})—OCO—(CᵣH₂ᵣ)—COO—.

In the above formulae, a, b, and r have the same definitions as described above.

The addition amount of the surfactant in the liquid crystal composition is preferably 0.01 mass % to 10 mass %, more preferably 0.01 mass % to 5 mass %, and still more preferably 0.02 mass % to 1 mass % with respect to the total mass of the polymerizable liquid crystal compound.

Chiral Agent (Optically Active Compound)

The chiral agent has a function of causing a helical structure of a cholesteric liquid crystal phase to be formed. The chiral compound may be selected depending on the purpose because a helical twisting direction or a helical pitch derived from the compound varies.

The chiral agent is not particularly limited, and a well-known compound (for example, Liquid Crystal Device Handbook (No. 142 Committee of Japan Society for the Promotion of Science. 1989), Chapter 3, Article 4-3, chiral agent for TN or STN, p. 199), isosorbide, or an isomannide derivative can be used.

In general, the chiral agent includes an asymmetric carbon atom. However, an axially asymmetric compound or a surface asymmetric, compound not having an asymmetric carbon atom can be used. Examples of the axially asymmetric compound or the surface asymmetric compound include binaphthyl, helicene, paracyclophane, and derivatives thereof. The chiral agent may include a polymerizable group. In a case where both the chiral agent and the liquid crystal compound have a polymerizable group, a polymer which includes a repeating unit derived from the polymerizable liquid crystal compound and a repeating unit derived from the chiral agent can be formed due to a polymerization reaction of a polymerizable chiral agent and the polymerizable liquid crystal compound. In this configuration, it is preferable that the polymerizable group included in the polymerizable chiral agent is the same as the polymerizable group included in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group,

In addition, the chiral agent may be a liquid crystal compound.

In a case where the chiral agent includes a photoisomerization group, a pattern having a desired reflection wavelength corresponding to an emission wavelength can be finned by photomask exposure of an actinic ray or the like after coating and orientation, which is preferable. As the photoisomerization group, an isomerization portion of a photochromic compound, azo, azoxy, or a cinnamoyl group is preferable. Specific examples of the compound include compounds described in JP2002-80478A, JP2002-80851A, JP2002-179668A, JP2002-179669A, JP2002-179670A, JP2002-179681A, JP2002-179682A, JP2002-338575A, JP2002-33$668A, JP2003-313189A, and JP2003-313292A.

The content of the chiral agent in the liquid crystal composition is preferably 0.01 mol % to 200 mol % and more preferably 1 mol % to 30 mol % with respect to the amount of the polymerizable liquid crystal compound.

The chiral agent used in the present invention is a material which has an asymmetric carbon atom and is mixed with a nematic liquid crystal to form a chiral nematic phase, and may be polymerizable. As shown in Formula (12), a material having an acrylate structure is polymerizable by ultraviolet irradiation, which is preferable.

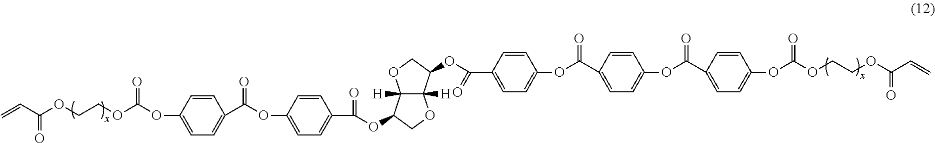

In the formula, X represents 2 to 5 (integer).

Polymerization Initiator

In a case where the liquid crystal composition includes a polymerizable compound, it is preferable that the liquid crystal composition includes a polymerization initiator. In a configuration where a polymerization reaction progresses with ultraviolet irradiation, it is preferable that the polymerization initiator is a photopolymerization initiator which initiates a polymerization reaction with ultraviolet irradiation. Examples of the photopolymerization initiator include an α-carbonyl compound (described in U.S. Pat. No. 2,367,661A and U.S. Pat. No. 2,367,670A), an acyloin ether (described in U.S. Pat. No. 2,448,828A), an a-hydrocarbon-substituted aromatic acyloin compound (described in U.S. Pat. No. 2,722,512A), a polynuclear quinone compound (described in U.S. Pat. No. 3,0461,27A and U.S. Pat. No. 2,951,758A), a combination of a triaryl imidazole dimer and p-aminophenyl ketone (described in U.S. Pat. No. 3,549,367A), an acridine compound and a phenazine compound (described in JP1985-105667A (JP-S60-105667A) and U.S. Pat. No. 4,239,850A), and an oxadiazole compound (described in U.S. Pat. No. 4,212,970A).

The content of the photopolymerization initiator in the liquid crystal composition is preferably 0.1 to 20 mass % and more preferably 0.5 mass % to 5 mass % with respect to the content of the polymerizable liquid crystal compound.

Crosslinking Agent

In order to improve the film hardness after curing and to improve durability, the liquid crystal composition may arbitrarily include a crosslinking agent. As the crosslinking agent, a curing agent which can perform curing with ultraviolet light, heat, moisture, or the like can be preferably used.

The crosslinking agent is not particularly limited and can be appropriately selected depending on the purpose. Examples of the crosslinking agent include: a polyfunctional acrylate compound such as trimethylol propane tri(meth)acrylate or pentaerythritol tri(meth)acrylate; an epoxy compound such as glycidyl (meth)acrylate or ethylene glycol diglycidyl ether; an aziridine compound such as 2,2-bis hydroxyinethyl butanol-tris[3-(1-aziridinyl)propionate] or 4,4-bis(ethyleneiminocarbonylamino)diphenylmethane; an isocyanate compound such as hexamethylene diisocyanate or a biuret type isocyanate; a polyoxazolinc compound having an oxazoline group at a side chain thereof; and an alkoxysilane compound such as vinyl trimethoxysilane or N-(2-aminoethyl)-3-aminopropyltrimethoxysilane. In addition, depending on the reactivity of the crosslinking agent, a well-known catalyst can be used, and not only film hardness and durability but also productivity can be improved. Among these curing agents, one kind may be used alone, or two or more kinds may be used in combination.

The content of the crosslinking agent is preferably 3 mass % to 20 mass % and more preferably 5 mass % to 15 mass %. In a case where the content of the crosslinking agent is lower than 3 mass %, an effect of improving the crosslinking density may not be obtained. In a case where the content of the crosslinking agent is higher than 20 mass %, the stability of a cholesteric liquid crystal layer may deteriorate.

Other Additives

In addition, the liquid crystal composition may include a polymerizable monomer (preferably, an amorphous monomer). In a case where an ink jet method described below is used as a method of forming the wavelength selective reflection portion (preferably the dot), a monofunctional polymerizable monomer may be used in order to obtain generally required ink properties. Examples of the monofunctional polymerizable monomer include 2-methoxyethyl acrylate, isobutyl acrylate, isooctyl acrylate, isodecyl acrylate, and octyl/decyl acrylate.

In addition, optionally, a polymerization inhibitor, an antioxidant, a ultraviolet absorber, a light stabilizer, a colorant, metal oxide particles or the like can be added to the liquid crystal composition in a range where optical performance and the like do not deteriorate.

Solvent

It is preferable that the liquid crystal composition is used as a liquid during the formation of the wavelength selective reflection portion.

The liquid crystal composition may include a solvent. The solvent is not particularly limited and can be appropriately selected depending on the purpose. An organic solvent is preferably used.

The organic solvent is not particularly limited and can be appropriately selected depending on the purpose. Examples of the organic solvent include a ketone such as methyl ethyl ketone or methyl isobutyl ketone, an alkyl halide, an amide, a sulfoxide, a heterocyclic compound, a hydrocarbon, an ester, and an ether. Among these organic solvents, one kind may be used alone, or two or more kinds may be used in combination. Among these, a ketone is more preferable in consideration of an environmental burden. The above-described component such as the above-described monofunctional polymerizable monomer may function as the solvent.

Formation of Wavelength Selective Reflection Portion

It is preferable that the liquid crystal composition is applied to the substrate and then is cured to form the wavelength selective reflection portion. The application of the liquid crystal composition to the substrate is preferably performed by jetting. In a ease where a plurality of wavelength selective reflection portions are formed on the substrate, the liquid crystal composition may be printed as an ink. A printing method is not particularly limited and, for example, an ink jet method, a gravure printing method, or a flexographic printing method can be used. Among these, an ink jet method is preferable. The pattern of the wavelength selective reflection portions can also be formed using a well-known printing technique.

It is preferable that the liquid crystal composition applied to the substrate is optionally dried or heated and then cured. In a drying or heating step, the polymerizable liquid crystal compound in the liquid crystal composition only has to be oriented. In the case of heating, the heating temperature is preferably 200° C. or lower and more preferably 130° C. or lower.

The oriented liquid crystal compound may be further polymerized. Regarding the polymerization, thermal polymerization or photopolymerization using light irradiation may be performed, and photopolymerization is preferable. Regarding the photopolymerization, ultraviolet light is preferably used. The irradiation energy is preferably 20 mJ/cm² to 50 mJ/cm² and more preferably 100 mJ/cm² to 1500 mJ/cm². In order to promote a photopolymerization reaction, photopolymerization may be performed under heating conditions or in a nitrogen atmosphere. The wavelength of irradiated ultraviolet light is preferably 250 nm to 430 nm. From the viewpoint of stability, the polymerization degree is preferably high, and is preferably 70% or higher and more preferably 80% or higher.

The polymerization degree can be determined by obtaining a consumption ratio between polymerizable functional groups using an IR absorption spectrum.

<Overcoat Layer>

The optical member may include an overcoat layer. The overcoat layer may be provided on a surface of the substrate where the wavelength selective reflection portion is formed, and it is preferable that the surface of the optical member is smoothened.

The overcoat layer is not particularly limited and is preferably a resin layer having a refractive index of about 1.4 to 1.8. The refractive index of the wavelength selective reflection portion formed of the liquid crystal material is about 1.6. By using an overcoat layer having a refractive index close to 1.6, the angle (polar angle) of light, which is actually incident on the wavelength selective reflection portion, from the normal line can be reduced. For example, in a case where the overcoat layer having a refractive index of 1.6 is used and light is incident on the optical member at a polar angle of 45°, a polar angle at which light is reliably incident on the wavelength selective reflection portion can be made to be about 27°. Therefore, by using the overcoat layer, the polar angle of light at which the optical member exhibits retroreflection properties can be widened, and high retroreflection properties can be obtained at a wider angle even in the wavelength selective reflection portion which is opposite to the substrate and forms a small angle with the substrate. In addition, the overcoat layer may function as an anti-reflection layer, a pressure sensitive adhesive layer, an adhesive layer, or a hard coat layer.

Examples of the overcoat layer include a resin layer which is obtained by applying composition including a monomer to the surface of the substrate (the underlayer constituting the substrate) where the wavelength selective reflection portion is formed, and curing the coating film. The resin is not particularly limited and may be selected in consideration of, for example, adhesiveness with the substrate (the underlayer constituting the substrate) or the liquid crystal material for forming the wavelength selective reflection portion. For example, a thermoplastic resin, a thermosetting resin, or a ultraviolet curable resin can be used. From the viewpoints of durability, solvent resistance, and the like, a resin which is curable by crosslinking is preferable, and an ultraviolet curable resin which is curable within a short period of time is more preferable. Examples of the monomer which can be used for forming the overcoat layer include ethyl (meth)acrylate, ethylhexyl (meth)acrylate, styrene, methylstyrene, N-vinylpyrrolidone, polymethylol propane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa acrylate, 1,6-hexanediol di(meth)acrylate, and neopentyl glycol di(meth)acrylate.

The thickness of the overcoat layer may be selected depending on the maximum height of the wavelength selective reflection portion without any particular limitation, and is preferably about 5 μm to 100 μm, more preferably 10 μm to 50 μm, and still more preferably 20 μm to 40 μm. The thickness is the distance from a surface of the substrate, where the wavelength selective reflection portion is formed, to a surface of the overcoat layer provided on a surface of the substrate, where the wavelength selective reflection portion is not formed, which is opposite to the surface where the wavelength selective reflection portion is formed.

<Application of Optical Member>

The application of the optical member according to the present invention is not particularly limited and can be used as various reflection members. Examples of the application of the optical member according to the present invention includes applications described in paragraphs “0021” to “0032” of JP2008-108236A, the content of which is incorporated herein by reference. For example, the optical member according to the present invention is attached to a display device such that it can be used for directly handwriting data on the display device using a pen or the like to input data.

In particular, regarding the optical member where the wavelength selective reflection portions (for example, dots) are provided in a pattern shape, for example, by forming the pattern as a dot pattern which is encoded to present position information, the optical member can be used as an input medium which is used in combination with input means such as an electronic pen for converting handwritten information into digital data and inputting the digital data into an information processing device. The optical member is used after preparing a material for forming the wavelength selective reflection portion such that the wavelength of light irradiated from the input means is the same as that where the wavelength selective reflection portion exhibits reflecting properties. Specifically, the helical pitch of the cholesteric structure may be adjusted using the above-described method.

The optical member according to the present invention can also be used as an input medium such as an input sheet on a display screen such as a liquid crystal display. At this time, it is preferable that the optical member is transparent. The optical member may be attached to a display screen directly or with another film interposed therebetween so as to be integrated with a display, or may be detachably mounted on a display screen. At this time, it is preferable that the wavelength range of light where the wavelength selective reflection portion (for example, the dot) in the optical member according to the present invention exhibits selective reflection is different from that of light emitted from a display. That is, it is preferable that the wavelength selective reflection portion (for example, the dot) has selective reflecting properties in the invisible range and that the display emits invisible light such that a detecting device does not detect light erroneously.

The details of an handwriting input system for converting handwritten information into digital data and inputting the digital data into an information processing device can be found in, for example, JP2014-67398A, JP2014-98943A, JP2008-165385A, paragraphs “0021” to “0032” of JP2008-108236A, or JP2008-077451A.

It is preferable that the optical member according to the present invention is a sheet which is mounted on or in front of a surface of an image-displayable device. Examples of a preferable embodiment of the sheet which is mounted on or in front of a surface of an image-displayable device include an embodiment described in paragraphs “0024” to “0031” of JP4725417B.

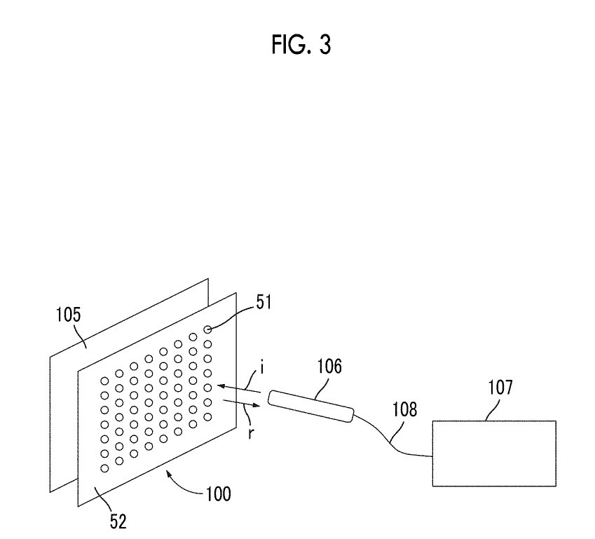

FIG. 3 is a schematic diagram showing a system in which the optical member according to the present invention is used as a sheet which is mounted on or in front of a surface of an image-displayable device.

In FIG. 3, a well-known sensor may be used without any particular limitation as long as it emits infrared light i and can detect reflected light r from the above-described pattern. Examples of a pen type input terminal 106 including a read data processing device 107 include an input terminal described in JP2003-256137A including: a pen point that does not include an ink, graphite, or the like; a CMOS camera that includes an infrared irradiating portion; a processor, a memory; a communication interface such as a wireless transceiver using a Bluetooth (registered trade name) technique; and a battery.

Regarding the operation of the pen type input terminal 106, for example, the pen point is drawn in contact with a front surface of the optical member 100 according to the present invention, the pen type input terminal 106 detects a writing pressure applied to the pen point, and the CMOS camera operates such that a predetermined range around the pen point is irradiated with infrared light at a predetermined wavelength which is emitted from the infrared irradiating portion and such that the pattern is imaged (for example, the pattern is imaged several ten times to several hundred times per second). in a case where the pen type input terminal 106 includes the read data processing device 107, the imaged pattern is analyzed by the processor such that an input trajectory generated by the movement of the pen point during handwriting is converted into numerical values and data to generate input trajectory data, and the input trajectory is transmitted to an information processing device.

Members such as the processor, the memory, the, communication interface, such as a wireless transceiver using a Bluetooth (registered trade name) technique, or the battery may be provided outside of the pen type input terminal 106 as the read data processing device 107 as shown in FIG. 3. In this case, the pen type input terminal 106 may be connected to the read data processing device 107 through a cord 108, or may transmit read data wirelessly using an electric wave, infrared light, or the like.

In addition, the input terminal 106 may be a reader described in JP2001-243006A.

The read data processing device 107 which can be used in the present invention is not particularly limited as long as it has a function of calculating position information based on continuous image data read from the input terminal 106 and providing the calculated position information together with time information as generate input trajectory data which can be processed in an information processing device. The read data processing device 107 only has to include the members such as the processor, the memory, the communication interface, and the battery.

In addition, the read data processing device 107 may be embedded in the input terminal 106 as described in JP2003-256137A, or may be embedded in an information processing device including a display device. In addition, the read data processing device 107 may transmit the position information to an information processing device including a display device wirelessly, or may be connected thereto through a cord or the like.

In the information processing device connected to a display device 105, an image displayed on the display device 105 is sequentially updated based on trajectory information transmitted from the read data processing device 107 such that a trajectory which is handwritten by the input terminal 106 is displayed on the display device as if it was drawn on paper by a pen.

[Image Display Device]

An image display device according to the present invention includes the optical member according to the present invention.

It is preferable that the optical member according to the present invention is mounted on or in front of an image display surface of the image display device. A preferable embodiment of the image display device can be found in the above description regarding the application of the optical member.

The invention described in this specification also includes a system including the image display device in which the optical member according to the present invention is mounted on or in front of an image display surface.

### EXAMPLES

Hereinafter, the present invention will be described in detail using examples. Materials, reagents, amounts thereof, proportions thereof, operations, and the like shown in the following examples can be appropriately changed as long as they do not depart from the scope of the present invention. Accordingly, the scope of the present invention is not limited to the following examples.

[Preparation of Substrate Including Underlayer 1]

Underlayer-forming solution 1 for forming underlayer 1 was prepared by preparing propylene glycol monomethyl ether acetate in an amount shown in Table 1 below, adding Binder 2, a DPHA solution, 2,4-bis(trichloromethyl)-6-[4-(N,N -diethoxycarbonylmethyl)-3-bromophenyl]-s-triazine, and Surfactant 1 in this order while mixing the components at a temperature of 25° C. (±2° C.) at 150 rpm (round per minutes) for 10 minutes, adding a cyanine colorant having an absorption maximum of 830 nm described below as an infrared absorbing colorant, and stirring the components for 60 minutes. The amount of each component shown in Table 1 below are represented by mass %. The specific composition of each component is as follows.

TABLE 1

| Material Name | % |
|---|---|
| Propylene Glycol Monomethyl Ether Acetate | 77.1 |
| Binder 2 | 15.5 |
| 2,4-Bis(Trichloromethyl)-6-[4-(N,N-Diethoxycarbonylmethyl)- | 0.30 |
| 3-Bromophenyl]-s-Triazine | |
| DPHA Solution | 6.58 |
| Infrared Absorbing Colorant | 0.50 |
| Surfactant 1 | 0.03 |

<Binder 2>
Polymer (a random copolymer having a molar ratio benzyl methacrylate/methacrylic acid of 78/22, molecular weight: 38000): 27 mass %
Propylene glycol monomethyl ether acetate: 73 mass %

<DPHA Solution>

Dipentaerythritol hexaacrylate (also abbreviated as DPHA; including 500 ppm of a polymerization inhibitor MEHQ, trade name: KAYARAD DPHA, manufactured by Nippon Kayaku Co., Ltd.): 76 mass % Propylene glycol monomethyl ether: 24 mass %

<Surfactant 1>
The following Structure 1: 30 mass %
Methyl isobutyl ketone: 70 mass %

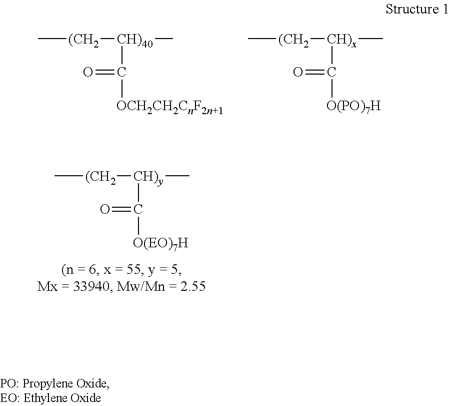

<Infrared Absorbing Colorant>

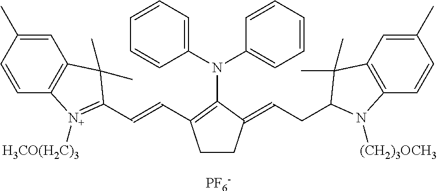

Underlayer-forming solution 1 prepared as described above was applied to a transparent polyethylene terephthalate (PET) support having a thickness of 95 μm using an bar coater in an application amount of 3 mL/m². Next, Underlayer-forming solution 1 was heated such that the film surface temperature was 90° C., and then was dried for 120 seconds. Next, in a nitrogen purged atmosphere having an oxygen concentration of 100 ppm or lower, 700 mJ/cm² of ultraviolet light was irradiated using an ultraviolet irradiation device to promote a crosslinking reaction. As a result, a laminate including a support and Underlayer 1 was prepared as a substrate.

[Preparation of Substrate Including Underlayer 2]

Components shown below were stirred and dissolved in a container held at 25° C. to prepare Underlayer-forming solution 2 for forming Underlayer 2.

### Underlayer-Forming Solution 2

Propylene glycol monomethyl ether acetate: 67.8 mass %

Dipentaerythritol hexaacrylate (trade name: KAYARAD DPHA, manufactured by Nippon Kayaku Co., Ltd.): 5.0 mass %

MEGAFACE RS-90 (manufactured by DIC Corporation): 26.7mass %

IRGACURE 819 (manufactured by BASF SE): 0.5 mass %

Underlayer-forming solution 2 prepared as described above was applied to a transparent polyethylene terephthalate (PET; COSMOSHINE A4100, manufactured by Toyobo Co., Ltd.) support having a thickness of 100 μm using an bar coater in an application amount of 3 mL/m². Next, Underlayer-forming solution 1 was heated such that the film surface temperature was 90° C., and then was dried for 120 seconds. Next, in a nitrogen purged atmosphere having an oxygen concentration of 100 ppm or lower, 700 mJ/cm² of ultraviolet light was irradiated using an ultraviolet irradiation device to promote a crosslinking reaction. As a result, a laminate including a support and Underlayer 2 was prepared as a substrate.

[Preparation of Substrate Including Underlayers 1 and 2]

Underlayer-forming solution 2 prepared as described above was applied to Underlayer 1 of the substrate, which was the laminate including the support and Underlayer 1, using an bar coater in an application amount of 3 mL/m². Next, Underlayer-forming solution 1 was heated such that the film surface temperature was 90° C., and then was dried for 120 seconds, Next, in a nitrogen purged atmosphere having an oxygen concentration of 100 ppm or lower, 700 mJ/cm² of ultraviolet light was irradiated using an ultraviolet irradiation device to promote a crosslinking reaction. As a result, a laminate including the support, Underlayer 1, and Underlayer 2 was prepared as a substrate.

[Preparation of Cholesteric Liquid Crystal Ink Solution 1]

100 parts by mass of a monomer including a polymerizable acrylate present at opposite terminals, mesogen present at the center, and a spacer present between the mesogen and the acrylate and having a nematic-isotropic transition temperature of about 110° C. (the above-described compound (11) having a molecular structure in which X¹ represents 2) and 3.3 parts by mass of a chiral agent having a polymerizable acryloyl group at opposite terminals (the above-described compound (12) having a molecular structure in which X represents 2) were dissolved in cyclohexanone to prepare a cyclohexanone solution (hereinafter, abbreviated as “anone solution”). 4 parts by mass of a photopolymerization initiator (LUCIRIN (registered trade name) TPO, manufactured by BASF Japan) was added to the anone solution.

The obtained anone solution was set as Cholesteric liquid crystal ink solution 1.

[Preparation of Cholesteric Liquid Crystal Ink Solution 2]

A composition shown below was stirred and dissolved in a container held at 25° C. to prepare Cholesteric liquid crystal ink solution 2.

### Cholesteric Liquid Crystal Ink Solution 2

Methoxyethyl acrylate: 145.0 parts by mass

A mixture of rod-shaped liquid crystal compounds having the following structures: 100.0 parts by mass

IRGACURE 819 (manufactured by BASF SE): 10.0 parts by mass

A chiral agent having the following structure: 3.8 parts by mass

A fluorine surfactant having the following structure: 0.08 parts by mass Rod-Shaped Liquid Crystal Compounds

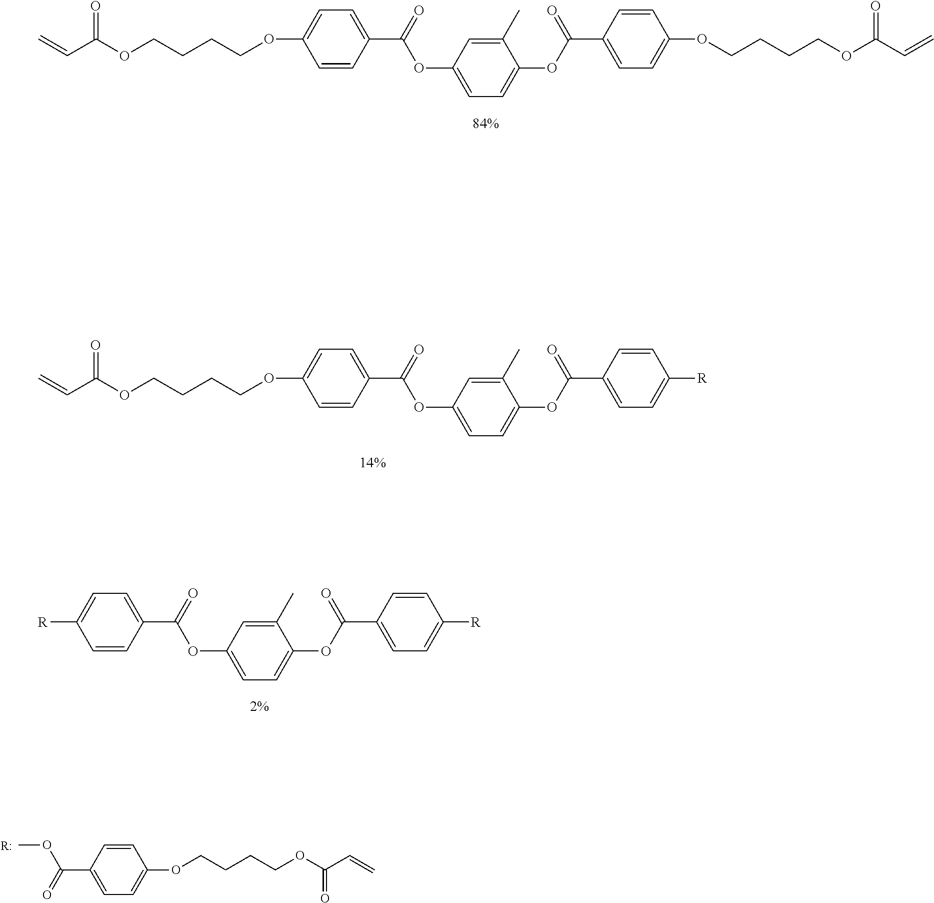

Numerical values are represented by mass %. In addition, a group represented by R is a partial structure present on the left and right sides, and this partial structure is bonded to an oxygen atom portion.

Chiral Agent

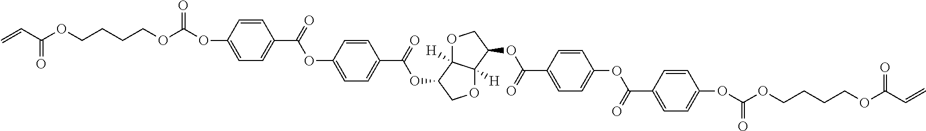 [SMILES: C=CC(=O)OCCCCOC(=O)Oc1ccc(C(=O)Oc2ccc(C(=O)O[C@H]3CO[C@H]4[C@@H]3OC[C@H]4OC(=O)c3ccc(OC(=O)c4ccc(OC(=O)OCCCCOC(=O)C=C)cc4)cc3)cc2)cc1]

Surfactant

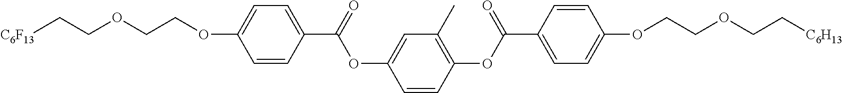

(Preparation of Cholesteric Liquid Crystal Ink Solutions 3 and 4)

Cholesteric liquid crystal inks solutions 3 and 4 were prepared using the same method as the preparation method of Cholesteric liquid crystal ink solution 2, except that the amount of the chiral agent was changed from 3.8 parts by mass to 4.1 parts by mass and 3.2 parts by mass, respectively.

### Examples 1 to 8 and Comparative Examples 1 and 2

Cholesteric liquid crystal dot patterns were obtained by using combinations of the underlayer and the cholesteric liquid crystal ink solution as shown in Table 2 below.

In a case where a combination of Underlayers 1 and 2 was used, Underlayers 1 and 2 were laminated in this order on the PET support. The details will be described below.

In Examples 1 to 8 and Comparative Examples 1 and 2, Cholesteric liquid crystal ink solutions 1 to 4 prepared as described above were applied to the entire 50×50 mm region of the underlayer of the substrate prepared as described above, which was the laminate including the PET support and Underlayer 1 and/or 2, using an ink jet printer (DMP-2831, manufactured by Fujifilm Dimatix Inc.) such that the distance between dot centers was 300 μm, the dot diameter was 50 μm, and the dot maximum height was 8 μm (a value obtained by dividing the maximum height by the dot diameter was 0.16). Next, Cholesteric liquid crystal ink solutions 1 to 4 were dried at 95° C. for 30 seconds. Next, by irradiating 500 mJ/cm² of ultraviolet light using an ultraviolet irradiation device, optical members including a cholesteric liquid crystal dot pattern as a wavelength selective reflection portion were prepared.

In Comparative Example 1, Cholesteric liquid crystal ink solution 1 prepared as described above was directly applied to the PET support without providing the underlayer.

The obtained optical members including a cholesteric liquid crystal dot pattern were set as optical members according to Examples and Comparative Examples.

In the optical members according to Examples and Comparative Examples, an overcoat layer was not provided. However, an overcoat layer may be appropriately provided

### Comparative Example 3

Using a method of forming an optical film according to Example 1 described in JP2008-209598A, an infrared absorbing ink was pattern-printed in a dot shape to form a dot pattern on an infrared diffuse reflection substrate obtained by applying an infrared reflecting ink to a PET support.

The obtained optical film including the dot pattern was set as an optical member according to Comparative Example 3.

[Evaluation]

### <S/N Ratio>

In the optical member according to each of Examples and Comparative Examples, the reflectance of the wavelength selective reflection portion (each dot portion constituting the dot pattern) and the reflectance of the underlayer portion at 850 am were measured using a specular reflectometer (V-550, manufactured by Jasco Corporation). Specifically, it was assumed that a normal direction perpendicular to the support and the underlayer of the optical member was set as 0°, a surface direction of the support and the underlayer of the optical member was set as 90°, and an angle in an infrared irradiation direction was set as + (positive). On this assumption, in a case where the optical member according to each of Examples and Comparative Examples was irradiated with infrared light at a wavelength of 850 nm in a direction of +20°, the amount of reflected light from an infrared receiving portion provided in a direction of +15° to +25° (approximately a direction of retroreflection) was measured.

The reflectance of the dot portion was calculated form the dot area included in a measurement aperture and was divided by the reflectance of the underlayer portion. As a result, a Signal/Noise ratio (also referred to as “S/N ratio”) was obtained.

The obtained results are shown in Table 2 below.

<Shape of Wavelength Selective Reflection Portion and Evaluation of Cholesteric Structure>

When the wavelength selective reflection portion (each dot constituting the dot pattern) of the optical member according to each of Examples 1 to 8 was observed using a scanning electron microscope (trade name: JSM-6510, manufactured by JEOL Ltd.), a stripe pattern including bright portions and dark portions was observed in a cross-sectional view of the dot.

Among the dots of the optical member obtained as described above, 10 dots were selected arbitrarily, and the shapes of the dots were observed using a laser microscope (manufactured by Keyence Corporation). The average diameter of the dots was 50 μm, the average maximum height was 8 μm, an average angle at a contact portion between a dot surface of a dot end portion and a underlayer surface was 36 degrees, and the height was continuously increased in a direction from the dot end portion to the center.

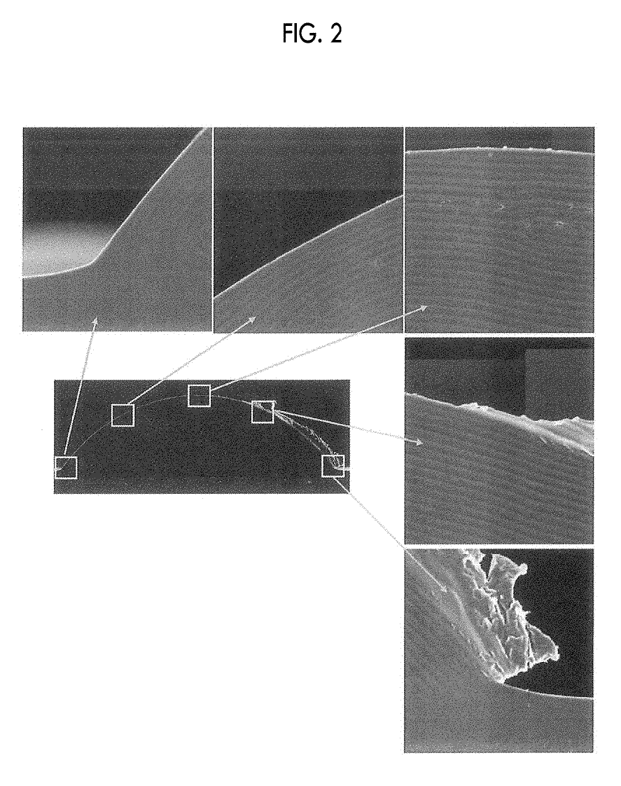

Regarding one dot positioned at the center of the obtained optical member, a surface including the dot center was cut in a direction perpendicular to the PET support, and the obtained cross-section was observed using the above-described scanning electron microscope. It was verified by the above-described scanning electron microscope that: the dot included in the optical member according to each of Examples 3 to 8 includes a portion having a height which continuously increased to a maximum height in a direction moving from an end portion of the dot to the center of the dot; and in the portion, an angle between a normal line perpendicular to a line, which was formed using a first dark portion from a surface of the dot opposite to the underlayer, and the surface was in a range of 70° to 90°. In addition, it was verified by the above-described scanning electron microscope that, in an end portion of the dot included in the optical member according to each of Examples 3 to 8, an angle between the surface of the dot, which is opposite to the underlayer, and a surface of the underlayer was 27° to 62°. Among the observation results of the optical members according to Examples 1 to 8 using the scanning electron microscope, an image of the dot according to Example 4 as a representative example observed by the scanning electron microscope is shown in FIG. 2. A stripe pattern including bright portions and dark portions was observed in the dot, and a cross-sectional view shown in FIG. 2 was obtained (FIG. 2 is a cross-sectional view showing the optical member according to Example 4, and a portion present outside of a hemispherical shape on the right side of the cross-sectional view is a burr generated during cutting).

In the cross-sectional view, an angle between a normal direction perpendicular to a line, which was formed using a first dark portion from an air interface-side surface of the dot, and the air interface-side surface was measured. The angles measured at a dot end portion, at a portion between the dot end portion and the dot center, at the dot center were 90 degrees, 89 degrees, and 90 degrees, respectively. Further, regarding an angle between the normal direction of the line formed using the dark portion and a normal direction perpendicular to the PET support, the values measured at a dot end portion, at a portion between the dot end portion and the dot center, at the dot center were 35 degrees, 18 degrees, and 0 degrees, respectively, which were continuously decreased.

<Performance Evaluation of Wavelength Selective Reflection Portion>

The transmittance and haze of the optical member according to Example 3 prepared as described above were measured using a haze meter (manufactured by Nippon Denshoku Industries Co., Ltd.). The non-polarized light transmittance (total transmittance) at a wavelength of 380 to 780 nm was 89.0%, and the haze was 0.4%. The transmittance values of the optical members according to the other Examples were measured, and the transmittance values at 550 nm were 88% or higher. Likewise, the haze values of the optical members according to the other Examples and Comparative Examples were measured and were 2% or lower.

In addition, using an visible and near-infrared light source (HL-2000, manufactured by Ocean Optics Inc.), a ultra high-resolution multi-channel fiber spectrophotometer (HR4000), and a 2-branched optical fiber, the wavelength selective reflecting properties of the optical member according to each of Examples 3 and 4 were measured in 5 arbitrary visual fields having a diameter of 2 mm. In all the visual fields, the reflection peak wavelengths were 850 nm, and wavelength selective reflecting properties in which a center wavelength was present at 850 nm were exhibited. Likewise, the wavelength selective reflecting properties of the optical members according to the other Examples were measured, and the following results were found. In the optical members according to Examples 1 to 6, the selective reflection wavelengths were 830 to 880 nm. The optical member according to Example 7 exhibited wavelength selective reflecting properties in which a center wavelength was present at 800 nm. The optical member according to Example 8 exhibited wavelength selective reflecting properties in which a center wavelength was present at 860 nm.

In addition, in the optical members according to Examples 3 to 8, all the dots constantly exhibited retroreflection properties in a polar angle range of 0 to 50 degrees in a case where the normal line perpendicular to the optical member was set as 0 degrees.

<Evaluation of Underlayer>

In addition, the absorbance to invisible light (in Examples, the absorbance at a wavelength of 850 nm), which was light in a wavelength range where the wavelength selective reflection portion exhibited selective reflecting properties, was obtained based on the transmittance at a wavelength of 850 nm which was obtained using the same device as that used for obtaining the reflectance at 850 nm. The absorbance of the PET support at 850 nm was 10%, the absorbance of Underlayer 1 including the infrared absorbing colorant at 850 nm was 30%, and the absorbance of Underlayer 2 not including the infrared absorbing colorant at 850 nm was 10%. In the underlayer absorbing invisible light, the absorbance to invisible light at a specific wavelength is preferably higher than 10%, more preferably higher than 15%, still more preferably higher than 20%, and still more preferably higher than 25%. A layer in which the absorbance to invisible light at a specific wavelength is 10% or lower can be considered as a layer which does not substantially absorb invisible light. Therefore, it can be seen that Underlayer 1 corresponds to the underlayer absorbing invisible light and that the PET support and underlayer 2 do not substantially absorb invisible light.

TABLE 2

| | Cholesteric | | | |
|---|---|---|---|---|
| | Liquid | Underlayer | Underlayer | S/N |
| | Crystal Ink | 1 | 2 | Ratio |
| Example 1 | 1 | Provided | Not | 1.7 |
| | | | Provided | |
| Example 2 | 1 | Provided | Provided | 2.6 |
| Example 3 | 2 | Provided | Not | 3.9 |
| | | | Provided | |
| Example 4 | 2 | Provided | Provided | 5.2 |
| Example 5 | 3 | Provided | Not | 3.6 |
| | | | Provided | |
| Example 6 | 3 | Provided | Provided | 4.9 |
| Example 7 | 4 | Provided | Not | 3.5 |
| | | | Provided | |
| Example 8 | 4 | Provided | Provided | 4.8 |
| Comparative | 1 | Not | Not | 0.9 |
| Example 1 | | Provided | Provided | |
| Comparative | 1 | Not | Provided | 1.1 |
| Example 2 | | Provided | | |

| | | |
|---|---|---|
| Comparative | Dot Pattern Described in JP2008-209598A | 1.1 |
| Example 3 | | |

It was found from Table 2 that, in the optical member according to the. present invention, a Signal/Noise ratio is high which is a ratio of a reflectance of the wavelength selective reflection portion to a reflectance of the underlayer in a wavelength range where the wavelength selective reflection portion has selective reflecting properties. It was also found that, particularly in a case where underlayer 1 and underlayer 2 are used in the optical member according to the present invention, the contact angle between the dot pattern and the substrate (the angle between the surface of the dot, which is opposite to the substrate, and the substrate (the surface of the substrate where the dot is formed)) is improved by Underlayer 1, and due to this Signal intensity improving effect, the S/N ratio is further improved.

It was found from the results of Comparative Example 1 that, in a case where the underlayer is not provided on the PET support, the Signal/Noise ratio is low.

It was found that from the results of Comparative Example 2 that, in a case where the underlayer is provided but does not absorb invisible light, the Signal/Noise ratio is low.

It was found that from the results of Comparative Example 3 that, in a case where the underlayer diffuses and reflects infrared light without absorbing invisible light and where the dot pattern absorbs infrared light without reflecting invisible light, the Signal/Noise ratio is low.

### INDUSTRIAL APPLICABILITY

A member in which an infrared reflection pattern is formed using the optical member according to the present invention can be used as a sheet mounted on a display front surface with an infrared reflection pattern which is applicable to a data input system in which data can be handwritten directly on a screen of an image display device. In addition, even in a case where the above-described member is used as an infrared reflection pattern-formed transparent sheet which can provide information regarding the position of the input terminal on the transparent sheet, an image close to the display screen itself can be obtained irrespective of the infrared reflection pattern by reading the infrared reflection pattern using an input terminal capable of irradiating and detecting infrared light. Therefore, the optical member according to the present invention is easy to use, has high practical performance, and can be used in various portable terminals such as a mobile phone or a PDA and various information processing devices such as a personal computer, a video telephone, a television having an intercommunication function, or an internet terminal.

In addition, in a preferable embodiment of the optical member according to the present invention, an infrared reflection pattern which is extremely inconspicuous in the visual range can be obtained. For example, it is considered that, as an information medium of an authenticity determination system for an ID card, an IR reflection pattern portion is more inconspicuous and has an advantageous effect from the viewpoint of crime prevention and has an advantageous effect in increasing the degree of freedom for the design of a card.

### EXPLANATION OF REFERENCES

1: wavelength selective reflection portion
2: substrate
3: support
4: underlayer
5: overcoat layer
100: optical member
105: display device
106: pen type input terminal
107: read data processing device
108: cord

What is claimed is:

1. An optical member comprising a support, an underlayer, and a wavelength selective reflection portion in this order,
wherein the wavelength selective reflection portion has wavelength selective reflecting properties,
the wavelength selective reflection portion has a cholesteric structure,
the cholesteric structure has a stripe pattern including bright portions and dark portions in a cross-sectional view of the wavelength selective reflection portion when observed with a scanning electron microscope,
the underlayer absorbs invisible light, and
a wavelength range where the wavelength selective reflection portion has selective reflecting properties overlaps a wavelength range of invisible light absorbed by the underlayer.

2. The optical member according to claim 1,
wherein the cholesteric structure includes a liquid crystal material having a cholesteric liquid crystal structure.

3. The optical member according to claim 2,
wherein the liquid crystal material includes a surfactant.

4. The optical member according to claim 3,
wherein the surfactant is a fluorine surfactant.

5. The optical member according to claim 3,
wherein the liquid crystal material is a material obtained by curing a liquid crystal composition including a liquid crystal compound, a chiral agent, and the surfactant.

6. The optical member according to claim 1,
wherein a plurality of the wavelength selective reflection portions are provided in a pattern shape on a surface of the underlayer.

7. The optical member according to claim 1,
wherein the wavelength selective reflection portion is a dot.

8. The optical member according to claim 7,
wherein the dot includes a portion having a height which continuously increases to a maximum height in a direction moving from an end portion of the dot to the center of the dot, and
in the portion, an angle between a normal line perpendicular to a line, which is formed using a first dark portion from a surface of the dot opposite to the underlayer, and the surface is in a range of 70° to 90°.

9. The optical member according to claim 7,
wherein a diameter of the dot is 20 to 200 μm.

10. The optical member according to claim 7,
wherein a diameter of the dot is 30 to 120 μm.

11. The optical member according to claim 8,
wherein a value obtained by dividing the maximum height by the diameter of the dot is 0.13 to 0.30.

12. The optical member according to claim 7,
wherein in the end portion of the dot, an angle between the surface of the dot opposite to the underlayer and a surface of the underlayer is 27° to 62°.

13. The optical member according to claim 7,
wherein a reflection pattern of the wavelength selective reflection portion having the pattern shape is read using an input terminal, which is capable of irradiating and detecting invisible light, so as to provide information regarding a position of the input terminal on the optical member.

14. The optical member according to claim 1,
wherein the underlayer includes a compound having an absorption maximum at 760 nm to 1200 nm.

15. The optical member according to claim 1,
wherein the wavelength selective reflection portion has wavelength selective reflecting properties in which a center wavelength is present in an infrared range,

16. The optical member according to claim 15,
wherein the wavelength selective reflection portion has wavelength selective reflecting properties in which a center wavelength is present at a wavelength of 800 to 950 nm.

17. The optical member according to claim 1 which is transparent in a visible range.

18. An image display device comprising the optical member according to claim 1.
